(19) United States
(12) Patent Application Publication
(10) Pub. No.: US 2026/0043237 A1
(43) Pub. Date: Feb. 12, 2026

(54) AIR EXTRACTION INTERFACE WITH SEALING STRUCTURE, POLYCARBONATE VACUUM PLATE, AND SUNLIGHT ROOM

(71) Applicant: Lin Zhang, Taizhou (CN)

(72) Inventor: Lin Zhang, Taizhou (CN)

(21) Appl. No.: 18/830,628

(22) Filed: Sep. 11, 2024

Related U.S. Application Data
(63) Continuation of application No. PCT/CN2024/112386, filed on Aug. 15, 2024.

(30) Foreign Application Priority Data
Aug. 8, 2024 (CN) 202411088612.0

(51) Int. Cl. E04C 2/52; A01G 31/00

(52) U.S. Cl. CPC E04C 2/523; A01G 31/00

(57) ABSTRACT

An air extraction interface with a sealing structure, a polycarbonate vacuum plate, and a sunlight room are provided. The air extraction interface is an air extraction pipeline or an opening section. One end of the air extraction interface is connected to an air-extracted object. The sealing structure includes a first section located at the air extraction interface and a sealing section. Inner walls of pipelines of the air extraction interface where the first section is located fit each other or there is a gap between the inner walls. The pipelines of the air extraction interface are closed at a position where the sealing section is located. The sealing structure can easily seal the air extraction pipeline made of a hard material, so that air is prevented from entering internal vacuum space of the hard material in a sealing process.

### CROSS REFERENCE TO THE RELATED APPLICATIONS

This application is the continuation application of International Application No. PCT/CN2024/112386, filed on Aug. 15, 2024, which is based upon and claims priority to Chinese Patent Application No. 202411088612.0, filed on Aug. 8, 2024, the entire contents of which are incorporated herein by reference.

### TECHNICAL FIELD

The present invention relates to the field of novel building materials, particularly to a thermal insulating and transmitting material plate, and specifically relates to an air extraction interface with a sealing structure, a polycarbonate vacuum plate, and a sunlight room.

The polycarbonate vacuum plate is also known as a sunlight plate, a PC sunlight plate, and a PC vacuum plate.

The sunlight room is also known as a greenhouse, a sun-parlor, sunlight space, and a plant growing room/growth room, and plants such as vegetables and melons and fruits can be planted in the sunlight room. Organizations such as associations have stipulated specific meaning of some terms, and for example, American Architectural Manufacturers Association (AAMA) has stipulated specific meaning of some terms. However, in the present invention, the term “sunlight room” shall be regarded as a universal term and include all the terms described above. The sunlight room in the present invention is particularly the plant growth room in a preferred embodiment.

### BACKGROUND

After being picked, the water loss of vegetables can reach 10-20% within 24 h and 30-50% within 72 h; the amount of loss of vitamin C within 24 h reaches 20-30% and 50-70% within 72 h; the loss of proteins within 24 h can reach 5-10%, the amount of loss of fat can reach 2-5%, and the amount of loss of minerals can reach 1-3%. If any vegetable picked is not directly eaten, nutrients will be lost. Therefore, it is preferable for people with vegetable gardens where they can pick vegetables. An existing domestic soilless culture system cannot condition a vegetable growth environment and produces quite limited vegetables, so that it cannot meet the daily needs. With respect to reclamation in a backyard of a user, a technique for planting vegetables is required, the neat garden will be destroyed, a certain amount of labor is required, the user working in land is not clean, and a plenty of water needs to be watered. Moreover, wild animals and birds will eat the vegetables and it is a big trouble for preventing plant diseases and insect pests, so that there are rarely families planting vegetables in their backyards.

A patent literature US20210007304A1 discloses a growth system and method. The system is provided a movable crop supporting member. The crop supporting member is configured to propel downwards along a track to guide agricultural crops to pass through growth space along a spiral path, which allows planting of a plenty of crops within certain space, thereby achieving three-dimensional planting.

A patent literature US20230389496A1 discloses a movable aerial fog growth system for planting plants indoors such as a balcony and a kitchen, which achieves miniaturization and mobility of a planting system.

The above patent documents solve the problem of adjusting, controlling, and maintaining temperature and humidity of a small space environment around plants in family plant planting but does not solve the problem of controlling and keeping the temperature of large space where the plants are located, so that the patent documents are particularly not suitable for vegetable planting in a sunlight room in a region with low temperature at night. When the temperature is low at night, plants are easily frozen or pause growth; and when the temperature is high, the plants will enter abnormal growth states such as excessive growth or illness.

A patent literature US20240130300A1 discloses a greenhouse environment optimization method, pointing out that greenhouse crop growth is a highly coordinated combination of complex biological, environmental, mechanical, and management systems. The systems are organized to produce crops to satisfy market requirements. A control system guides a physical environment control system (for example, a heater, a cooler, and an irrigator) to respond to fluctuation of a natural external environment to satisfy instant plant growth requirements. However, the patent literature US20240130300A1 does not consider the energy consumption problem of heating and illumination control.

A patent literature US20210285282A1 discloses a variable thermal insulating assembly, pointing out that in a clear weather condition, it is usually expected to transmit sunlight to a building to the maximum extent to assist illumination and heating inside the building. On the contrary, in dark, cloudy or cloud weather conditions, it is usually expected to maximum heat insulation of the building so as to minimize the heat loss of the building. Usually, windows are used in the building, so that sunlight is transmitted to the building. Moreover, a sealing barrier which prevents wind, rain, snow, and other undesired components from entering is also provided. Although the windows usually provide light transmission with relatively high extent, which may be favorable for the clear weather condition, they also provide thermal insulation with low extent usually, which may be undesired for the dark, cloudy or cold weather conditions. Therefore, the patent literature US20210285282A1 provides a variable thermal insulating assembly, which includes an array of air sealing cavities or bags. The array is termed as a heat unit herein and can be adjusted between an expanding state and a compressed state. In the expanding state, the variable thermal insulating assembly provides a thermal insulating layer. In the compressed state, the variable thermal insulating assembly shrinks, so that the thermal insulating provided is reduced relative to that in the expanding state.

However, the patent literature US20210285282Al needs to be combined with a controller, which is complex in structure.

As an alternative solution, the patent literatures CN113711814A and CN217657336U use a polycarbonate material in a greenhouse, which is also called a PC plastic, PC for short. The PC vacuum plate is also known as the PC vacuum plate, or a PC sunlight plate or a sunlight plate. The PC vacuum plate features high transmissivity and better thermal insulating performance.

The thermal insulating performance of the PC vacuum plate is affected by a vacuum degree of a hollow interlayer. However, the patent literatures CN113711814A and CN217657336U do not solve the problem of how to obtain a better vacuum degree, that is, to reduce the air density.

The patent literature US20120225239A1 discloses temperature failure polycarbonate vacuum plate window glass, where a temperature failure part is used to reduce gas flow in hollow space.

However, on the premise of poor vacuumizing, the patent literature US20120225239A1 only plays an auxiliary role.

A patent literature US20150223410A1 discloses a vacuum chamber type greenhouse wallboard system, where a panel is vacuum-sealed and is interconnected to a vacuum pump and is kept connected. The vacuum pump is electronically controlled according to the temperature of the external temperature to compensate leakage.

It can be seen that if the sealing problem of the polycarbonate vacuum plate is not solved, the vacuum pump needs to compensate leakage all the way.

For sealing, a patent literature CN207748082U discloses a bag clamping part and a vacuum sealer provided with the bag clamping part. When a packaging bag is vacuum-scaled, a bag opening is placed in an annular retainer. By covering an upper cover, the bag opening is located in a sealing cavity. A sealing depression bar compresses a position to be sealed near the bag opening to a heating part. A vacuumizing part works to exhaust air in the vacuum cavity together with air in the packaging bag. Then, the heating part produces heat, so that the position to be sealed of the packaging bag is hot-sealed.

However, the sealing solution of the patent literature CN207748082U is not suitable for sealing the polycarbonate vacuum plate (i.e., the PC vacuum plate). First, in the solution of the patent literature CN207748082U, the bag opening of the packaging bag is placed in the vacuum cavity for heat sealing in the sealed vacuum environment. With respect to the polycarbonate vacuum plate, it is complex and highly cost to provide the sealed vacuum environment of the vacuum cavity. Second, the polycarbonate vacuum plate (i.e., the PC vacuum plate) is different from the packaging bag which is made of a flexible material. In a vacuumizing process, the packaging bag can be extruded flatly by atmosphere while the polycarbonate vacuum plate is made of a hard material at normal temperature. Third, there are textures between inner walls of the packaging bag, so that when the inner walls are pressed to adhere to each other therebetween, there is a gap as the textures cannot be aligned, so that vacuumizing is performed through the gap. However, it is hard to process the textures in the polycarbonate vacuum plate.

A patent literature CN112874873A discloses a vacuum sealer for processing a food packaging bag, which performs vacuumizing through an air extraction pipe and presses and hot-seals the bag opening rapidly at the moment when the air extraction pipe is extracted from the packaging bag.

However, the patent literature CN112874873A cannot solve the problem of air leakage caused at the moment when the air extraction pipe is extracted.

### SUMMARY

To overcome deficiencies in the prior art, an object of the present invention is to provide an air extraction interface with a sealing structure, a polycarbonate vacuum plate, and a sunlight room.

According to an air extraction interface with a sealing structure the air extraction interface provided by the present invention, the air extraction interface is an air extraction pipeline or an opening section;
one end of the air extraction interface is connected to an air-extracted object, and the sealing structure includes a first section located at the air extraction interface and a scaling section;
inner walls of pipelines of the air extraction interface where the first section is located fit each other or there is a gap between the inner walls;
the pipeline of the air extraction interface is closed at a position where the sealing section is located;
in an extension direction of the air extraction interface, one or more first sections are located on a side of the sealing section close to the air-extracted object; and
one or more first sections are located on a side of the sealing section away from the air-extracted object; or none of the first sections is located on a side of the sealing section away from the air-extracted object.

The air extraction pipeline with the sealing structure is used to effectively vacuumize and seal the hollow plate, such as a polycarbonate vacuum plate, made of the hard material effectively to form a vacuum plate, which prevents air from leaking into the vacuum plate made of the hard material during vacuumizing.

Preferably, a material of the air extraction interface is polycarbonate;
the first section made of polycarbonate is an extruded portion allowed to be formed by heating and softening the air extraction interface;
the sealing section made of polycarbonate is a portion allowed to be formed by hot-melting the air extraction interface; and
a length of the first section in the extension direction of the air extraction interface is greater than or equal to 1 mm, and a length of the sealing section in the extension direction of the air extraction interface is greater than or equal to 1 mm.

Polycarbonate is the material heated to soften and melt, which can be applied to preparing the sealing structure. Moreover, proper length design of the first section and the sealing section can guarantee reliable sealing of the air-extracted object and provides enough structural strength for sealing management during vacuumizing.

Preferably, the sealing structure further includes a second section located at the air extraction interface;
in the extension direction of the air extraction interface, the second section is located between the first section and the sealing section face to face, and heat resistance is formed between the first section and the sealing section in heat processing;
in the extension direction of the air extraction interface, a length of the second section is greater than or equal to 1 mm;
inner walls of pipelines of the air extraction interface where the second section is located fit each other or there is a gap or a cavity between the inner walls; and
the second section made of polycarbonate is an extruded portion allowed to be formed by heating and softening the air extraction interface.

The second section provides avoidance space between a tool for processing the first section and a tool for processing the sealing section.

According to a polycarbonate vacuum plate provided by the present invention, the polycarbonate vacuum plate includes a multilayered polycarbonate plate main body and the air extraction interface with the sealing structure,
where a hollow interior of the multilayered polycarbonate plate main body includes vacuum space; and
a sealing portion of at least one opening end of the multilayered polycarbonate plate main body and the air extraction pipeline of the air extraction interface with the sealing structure are of an integrally formed structure; or a portion of the multilayered polycarbonate plate main body serves as the opening section of the air extraction interface with the sealing structure.

Preferably, the multilayered polycarbonate plate main body includes a plurality of polycarbonate plates, and a plurality of spacers are connected between two polycarbonate plates face to face;
there is a spacing between an end portion of each of the spacers and the sealing portion of the opening end, and the spacing forms a channel connected to the spacers to divide the vacuum space into sub space; and
the channel is located on a side where the sealing portion of the multilayered polycarbonate plate main body is located, wherein the air extraction pipeline is located at the multilayered polycarbonate plate main body.

The multilayered polycarbonate vacuum plate can prevent heat conduction of both sides more effectively. The inner spacers can effectively play a supporting role to prevent the multilayered polycarbonate vacuum plate from being destroyed by external atmosphere in the vacuumized state.

Preferably, the vacuum space is provided with a gas absorbent and/or a vacuum degree indicator.

Residual gases in the polycarbonate vacuum plate can be absorbed through the gas absorbent, and the vacuum degree in the polycarbonate vacuum plate can be displayed through a degree-of-vacuum indicator, so that it is convenient to find the air-leaking polycarbonate vacuum plate timely.

According to a vacuum degree indicator applicable to the polycarbonate vacuum plate provided by the present invention, the vacuum degree indicator includes a hollow pipe, an air bag, and a shielding portion,
where the air bag is hermetically sleeved at one end of the hollow pipe, the shielding portion is connected to an end portion of the hollow pipe where the air bag is located and extends axially outwards, and the other end of the hollow pipe is sealed; and
when an external air pressure is lower than an internal air pressure of the hollow pipe, the air bag is shielded by the shielding portion; or when the external air pressure is higher than or equal to the internal air pressure of the hollow pipe, the air bag enters the hollow pipe under an action of the external air pressure and is exposed from the shielding portion.

The vacuum degree indicator can indicate whether the environment is vacuum.

Preferably, the vacuum degree indicator further includes the air extraction interface with the sealing structure,
where a material of the hollow pipe is polycarbonate; and
the other end of the hollow pipe and the air extraction interface are of an integrally formed structure.

The vacuum degree indicator uses the above sealing structure without additionally arranging the air extraction pipeline, which also can prevent air leakage during sealing effectively.

According to a method for preparing a polycarbonate vacuum plate provided by the present invention, the method includes the following steps:
a vacuumizing step: connecting a vacuumizing device to the air extraction interface to vacuumize the multilayered polycarbonate plate main body; and
a sealing step: heating, softening, and extruding a first portion of the air extraction interface to make inner walls of the extruded portion of the air extraction interface continuously fit each other to form a first, so as to temporarily close a pipeline of the air extraction interface; hot-melting and extruding a second portion of the air extraction interface to form a sealing section, to permanently close the pipeline of the air extraction interface; and removing extrusion to the first section, where the inner walls of the first section are maintained to fit each other or there is a gap between the inner walls of the first section.

The method for preparing a polycarbonate vacuum plate can prepare the polycarbonate vacuum plate effectively and has a reliable structural strength.

Preferably, the air extraction interface is an air extraction pipeline, and prior to the vacuumizing step, the method further includes the following step:
a pre-treating step: hot-melting and extruding an opening end of the multilayered polycarbonate plate main body to form a sealing portion;
milling spacers inside the multilayered polycarbonate plate main body from the other opening end of the multilayered polycarbonate plate main body, to form a channel connected to the spacers to divide the multilayered polycarbonate plate main body into sub space; and hot-melting and extruding the other opening end of the multilayered polycarbonate plate main body to form the air extraction pipeline with a channel connecting the sub space to external space of the multilayered polycarbonate plate main body;
or, the air extraction interface is an opening section of the multilayered polycarbonate plate main body.

The method for preparing a polycarbonate vacuum plate can vacuumize and seal the multilayered polycarbonate plate effectively to prevent gas from entering the polycarbonate vacuum plate in the sealing process.

Preferably, the method includes: in the extension direction of the air extraction pipeline, forming at least one first section on one side that is of the sealing section and that is away from the other opening end of the multilayered polycarbonate plate main body skipping forming the first section;
in the extension direction of the air extraction pipeline 1, forming at least one first section on one side that is of the sealing section and that is away from the other opening end of the multilayered polycarbonate plate main body, or skipping forming the first section, where
a heating temperature of the hot-melting is higher than or equal to 160° C., and a heating temperature of the softening is higher than or equal to 130° C. and lower than or equal to 140° C.; and
prior to the vacuumizing step, the method further includes: placing a gas absorbent and/or a vacuum degree indicator inside the multilayered polycarbonate plate main body.

The polycarbonate vacuum plate prepared by the method for preparing a polycarbonate vacuum plate has better thermal and sound insulation effects and also has reliable vacuum degree and structural strength, and is suitable for buildings such as sunlight room.

According to a polycarbonate vacuum plate provided by the present invention, the polycarbonate vacuum plate is prepared by the method for preparing a polycarbonate vacuum plate.

According to a sunlight room provided by the present invention, the sunlight room includes:
splicable and detachable panels 8, forming a closed or semi-closed plant growth space; and
an environmental conditioning system, controlling environment parameters of the plant growth space, where
each of the panels 8 includes the polycarbonate vacuum plate or the polycarbonate vacuum plate; or each of the panels 8 is provided with the air extraction interface with the sealing structure.

The plant growth room constructed by the polycarbonate vacuum plate has a better thermal insulating effect, and matches with the environmental conditioning system to control the environment parameters of the plant growth space, which effectively helps plant growth.

Preferably, the environmental conditioning system includes the following apparatuses located on an airflow path of the sunlight room:
a first ventilating apparatus, configured to adjust an air power source and to provide an air pressure difference between the inside and outside of the plant growth space by sucking or exhausting air in the space; and
a first water circulating apparatus, configured to adjust temperature and humidity in the plant growth space and to exchange air with the outside; and
the environmental conditioning system further includes the following one or more apparatuses:
a first illumination adjusting apparatus, configured to adjust an area at which natural sunlight projected at a top of the plant growth space is shielded;
a second illumination adjusting apparatus, configured to provide a light source directly illuminated inside the plant growth space;
a second ventilating apparatus, configured to adjust a contact area where air circulates freely between the inside and outside of the plant growth space;
a second water circulating apparatus, configured to spray clean water into the plant growth space periodically or according to temperature;
a third water circulating apparatus, configured to exchange heat between the air in the plant growth space and external underground soil;
a first irrigating apparatus, configured in a trough shape and located on a south side and/or an east side of the plant growth space to culture plants in a water culture method or an ebb and flow irrigation method;
a second irrigating apparatus, configured in a columnar shape and located in the middle of the plant growth space, wherein a plurality of layers of petaloid grooves are stacked axially to accommodate plants, or holes extend radially where leaves of the plants stretch, roots of the plants are left inside a column shaft, and the plants are cultured in the ebb and flow irrigation method;
a third irrigating apparatus, configured in a trough shape and located on a north side of the plant growth space to culture plants in a drip irrigation culture method;
a fourth irrigating apparatus, configured as a support with holes, where the plants pass through the holes, the roots are located on a backlit side of the support with holes, and the plants are cultured in an aerosol culture method;
a plurality of nutrient solution pools, mounted under a floor or on the floor of the sunlight room;
at least three fertilizing solution pools, mounted on a wall of a backlit surface of the sunlight room, where bottoms of the fertilizing solution pools are provided with a plurality of water pipes respectively connected to different nutrient solution pools; or one fertilizing solution pool, mounted on the wall of the backlit surface of the sunlight room, where the bottom of the fertilizing solution pool is provided with a water pipe connected to the nutrient solution pools; and the fertilizing solution pools are located above the floor and are not shielded; and
delivery pipelines, respectively connected to the nutrient solution pools to deliver nutrient solution to the roots of the plants;

The environmental conditioning system includes a temperature control system, an illumination control system, and a gas control system, which conditions the plant growth environment multi-dimensionally.

The environmental conditioning system includes an irrigation control system which satisfies different irrigation requirements of different plants.

The environmental conditioning system includes a nutrient solution control system which prepares nutrient solutions for different plants in a targeted manner.

Preferably, the fertilizer preparing and fertilizing system includes:
a low liquid level sensor, disposed at a first preset position within each of the nutrient solution pools;
a high liquid level sensor, disposed at a second preset position within each of the nutrient solution pools;
a controller, electrically connected to the low liquid level sensor and the high liquid level sensor and configured to open a tap water valve to add a preset amount of water into the nutrient solution pool when the low liquid level sensor detects that a liquid level of the nutrient solution pool is lower than the first preset position and to send a fertilization alarm signal to a mobile terminal, and to open the tap water valve to add water into the nutrient solution pool and to stir the mixture when a fertilization completion signal of the mobile terminal is received till the high liquid level sensor detects that the liquid level of the nutrient solution pool arrives at the second preset position; and
the mobile terminal, configured to prompt a user with a fertilizer needed to be added and to provide an operation completion button of a corresponding fertilizer when the fertilization alarm signal is received, and to send the fertilization completion signal to the controller when the operation completion buttons of all fertilizers are triggered.

Compared with the prior art, the present invention has the following beneficial effects:
1. The sealing structure provided by the present invention can easily seal the air extraction pipeline made of a hard material after air extraction is completed, so that air is prevented from entering internal vacuum space of the hard material in a sealing process.
2. The PC vacuum plate with the sealing structure provided by the present invention and prepared by the method is not only feasible in structural strength, but also can satisfy the performance requirements on construction of the sunlight room.
3. Problems that the air extraction interface cannot be fully sealed and air is leaked at the moment when the air extraction pipe is extracted due to ageing between the outer wall of the air extraction pipe and the inner wall of the air extraction pipeline of the polycarbonate vacuum plate during vacuumizing are avoided.
4. According to the present invention, the user can eat fresh vegetables at home conveniently. The present invention is a domestic sunlight room soilless culture system which is energy-saving and environmental-friendly, performs planting automatically, saves lands by three-dimensional planting, is suitable in four seasons, healthy and pollution-free, abundant in output, low in planting cost, and concise and beautiful in product. The present invention can help the user eat fresh vegetables to keep fit. Emission of tail gas is reduced by reducing the number of times of driving a car to a supermarket, and convenience of distributed life and work is improved.

### BRIEF DESCRIPTION OF THE DRAWINGS

By reading and referring to detailed description made by the following drawings to non-restrictive embodiments, other features, purposes and advantages of the present invention will become more obvious:

FIG. 1 is a schematic diagram of a first implementation of an air extraction pipeline with a sealing structure;

FIG. 2 is a schematic diagram of a second implementation of an air extraction pipeline with a sealing structure;

FIG. 3 is a schematic diagram of a third implementation of an air extraction pipeline with a sealing structure;

FIG. 4 is a structural schematic diagram of a sealed polycarbonate vacuum plate;

FIG. 5 is a structural schematic diagram of an unsealed polycarbonate vacuum plate;

FIG. 6 is a structural schematic diagram of a vacuum degree indicator when an external air pressure is lower than an internal air pressure of the vacuum degree indicator;

FIG. 7 is a structural schematic diagram of a vacuum degree indicator when an external air pressure is higher than an internal air pressure of the vacuum degree indicator;

FIG. 8 is a schematic diagram of preparation of an air extraction pipeline;

FIG. 9 is a schematic diagram of another sealing mode in which a hollow polycarbonate plate is sealed as a polycarbonate vacuum plate;

FIG. 10 is a schematic diagram of a working principle of sealing;

FIG. 11 is a schematic structural diagram of a plant growth room;

FIG. 12 is a schematic diagram of an irrigation control system and a nutrient solution control system;

FIG. 13 is a schematic diagram of an air flow path of the plant growth room;

FIG. 14 is a schematic diagram of positions of a water curtain and a fan;

FIG. 15 is a schematic structural diagram of an abat vent;

FIG. 16 is a schematic structural diagram of the water curtain; and

FIG. 17 is a flowchart of fertilizer preparation and fertilization.

In the drawings:
1, air extraction pipeline; 100, air-extracted object;
101, first section; 102, sealing section;
103, second section; 2, multilayered polycarbonate plate main body;
201, opening end; 202, sealing portion;
203, spacer; 204, polycarbonate plate;
205, spacing; 206, sub space;
209, opening section;
3, hollow pipe; 4, air bag;
5, shielding portion; 6, slotted clamp;
7, cylinder; 801, panel;
802, aluminum section frame; 803, shielding abat vent;
804, water curtain; 805, fan;
8041, top water pipe hole; 8042, multilayered kraft paper layer;
8043, collecting water pipe; 8044, high water level sensor;
8045, low water level sensor; 8046, UVC sterilizing lamp;
8047, water pump; 8048, electromagnetic valve;
806, nutrient solution pool; 807, delivery pipeline;
808, first irrigation device; 809, motor driven apparatus;
810, curtain; 811, pull rod arm;
9, air extraction pipe; 901, pipeline position;
701, high liquid level sensor; 702, low liquid level sensor.

### DETAILED DESCRIPTION OF THE EMBODIMENTS

People pay attention to healthy eating management increasingly and expect to intake fresh vegetables and melons and fruits. If people can plant vegetables in their own yards, this is beneficial to satisfying people's needs. To make the output of vegetables meet the quantity demanded every day of a family, certain vegetable planting space is needed. An area for vegetable planting is usually arranged outside a main body portion of a house, for example, a sunlight room.

It is found by the applicant by observing air temperature that at night in part of regions, the temperature is too low. Since most sunlight rooms are in an open-air environment, temperature beneficial for growth of vegetables cannot be provided inside the sunlight rooms at night or in some weather and climate conditions, even resulting in freezing of the plants. The reason is that wallboards and a top plate of the sunlight room occupy a primary

area in an in-out heat exchange process, which, thus, plays a primary role in thermal insulating performance of the sunlight room. A single-layered PC plate is not ideal in thermal insulating effect. Therefore, the applicant improves the single PC plate to a PC hollow plate (i.e., the polycarbonate hollow plate). Although the thermal insulating performance is somewhat improved, it is not ideal. It is found by further researches that the reason is that air is a good conductor of heat, and the thermal insulating effect of the PC hollow plate is limited. It is found by further researches that if the PC hollow plate is vacuumized to form a PC vacuum plate with a good vacuum degree, the thermal insulating performance of the PC vacuum plate can be greatly improved. This requires solution of the sealing problem of the PC vacuum plate. The polycarbonate vacuum plate has the problem of air leakage due to poor sealing. To seal the polycarbonate vacuum plate in the vacuumizing link is a problem.

Therefore, the applicant has tried physical adsorption, mechanical fastening, and glue which can be found on the market, through which the polycarbonate vacuum plate cannot be sealed well. Attempts have been made with various adhesive tapes, but no ways are found for solution.

The present invention will be described in detail below in combination with specific embodiments. The embodiments below contribute to further understanding the present invention by those skilled in the art but do not limit the present invention in any form. It should be noted that variations and improvements still can be made by those skilled in the technical field without departing the concept of the present invention. These fall into the scope of protection of the present invention.

### Embodiment 1

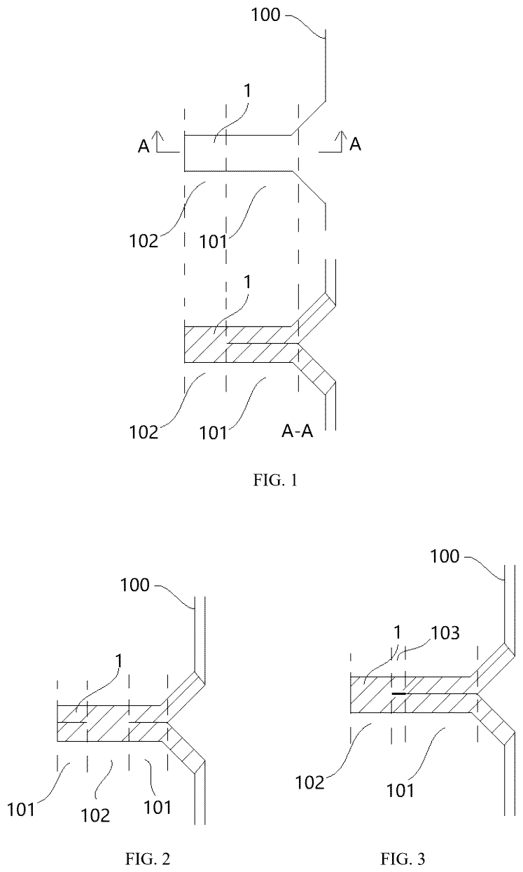

FIG. 1 is the embodiment 1. The embodiment provides an air extraction pipeline with a sealing structure, where one end of the air extraction pipeline 1 is connected to an air-extracted object 100 and the other end thereof is connected to air extraction equipment. The air-extracted object 100 is air-extracted for decompression or vacuumized, and the scaling structure is used to seal the air extraction pipeline 1 after air extraction is completed. The air-extracted object 100 is, for example, a polycarbonate vacuum plate prepared for forming vacuum, and the air extraction equipment is a vacuum pump.

As shown in FIG. 1, the sealing structure includes a first section 101 located on the air extraction pipeline 1 and a sealing section 102. A material of the air extraction pipeline 1 in the embodiment is polycarbonate, i.e., PC, which can be used in a scenario requiring good transmission of light and thermal insulation, for example, a sunlight room. In a preferred embodiment, the air extraction pipeline 1 and the air-extracted object 100 both are made of polycarbonate and are of an integrated structure.

Inner walls of pipelines of the air extraction pipeline 1 where the first section 101 is located fit each other or there is a gap between the inner walls, and the pipelines of the air extraction pipeline 1 are closed at a position where the sealing section 102 is located. In the embodiment, there is no limitation on the quantities of the first section 101 and the sealing section 102. For example, there may be a plurality of sealing sections 102.

Specifically, the first section 101 made of polycarbonate is an extruded portion allowed to be formed by heating and softening the air extraction pipeline 1. In the processing technology, the first section 101 is an extruded portion formed by heating and softening the air extraction pipeline 1. By heating the air extraction pipeline to 135° C., the air extraction pipeline 1 where the first section 101 is located is softened, and by extruding and keeping the position where the first section 101 is located through a clamp, inner walls of the pipelines of the air extraction pipeline 1 fit each other to form a temporary seal for the air-extracted object 100.

The first section 102 made of polycarbonate is the portion allowed to be formed by hot melting of the air extraction pipeline 1. In the processing technology, the first section 102 is the portion formed by hot-melting the air extraction pipeline 1. In a temporarily sealed state, in a non-limiting example, the air extraction pipe can be withdrawn, and the sealing section 102 is at a normal air pressure. By heating the air extraction pipe to 160° C., the air extraction pipeline 1 at the position where the sealing section 102 is located is hot-melted and clamped by the clamp, so that the air extraction pipeline 1 at the position where the sealing section 102 is closed. After the sealing section 102 is cooled, extrusion on the first section 101 is stopped, and in this case, inner walls of the air extraction pipeline 1 of the first section 101 may be kept in a fitted manner and may also rebound outwards to generate a gap because of the originally extruded portion of the air extraction pipeline 1.

In an implementation shown in FIG. 1, in an extension direction of the air extraction pipeline 1, at least one first section 101 is located on a side of the sealing section 102 close to the air-extracted object 100, and none of the first sections 101 is located on a side of the sealing section 102 away from the air-extracted object 100.

To guarantee the temporarily sealed effect inside the air-extracted object 100 in a vacuum state, a length of the first section 101 in the extension direction of the air extraction pipeline 1 is greater than or equal to 1 mm. To guarantee the finally sealed effect, the length of the first section 102 in the extension direction of the air extraction pipeline 1 is greater than or equal to 1 mm.

As shown in FIG. 1, the scaling section 102 is close to the first section 101, which, thus, can reduce or avoid air between the sealing section 102 and the first section 101 as far as possible to prevent the air from entering the air-extracted object 100 through the gap between the inner walls of the first sections 101 after stopping extrusion of the air on the first section 101 located on the side of the sealing section 102 close to the air-extracted object 100.

In a variable embodiment shown in FIG. 2, based on the implementation shown in FIG. 1, at least one first section 101 is located on a side of the sealing section 102 away from the air-extracted object 100.

As shown in FIG. 2, the first section 101 located on the side of the sealing section 102 away from the air-extracted object 100 also provide the temporary seal, and thus, both sides of the sealing section 102 are temporarily sealed, and the difference between the air pressures on both sides is quite small, so that the hot-melted inner wall is prevented from being promoted greatly by air pressure.

As shown in FIG. 3, as a non-limiting variable embodiment, based on the implementation shown in FIG. 1, the sealing structure further includes a second section 103 located on the air extraction pipeline 1. In the extension direction of the air extraction pipeline 1, the second section 103 is located between the first section 101 and the sealing section 102 face to face. Its object includes: when the first section 101 and the second section 102 are formed, the clamp will clamp the air extraction pipeline I at the same time; by designing the second section 103, interference caused by mutual contact between the clamp for the first section 101 and the clamp for the sealing section 102 is avoided.

In the extension direction of the air extraction pipeline 1, a length of the second section 103 is greater than or equal to 1 mm. Inner walls of pipelines of the air extraction pipeline 1 where the second section 103 is located fit each other or there is a gap or a cavity between the inner walls. Specifically, the second section 103 made of polycarbonate is an extruded portion allowed to be formed by heating and softening the air extraction pipeline 1. That is, the second section 103 is an extruded portion formed by heating and softening the air extraction pipeline 1.

### Embodiment 2

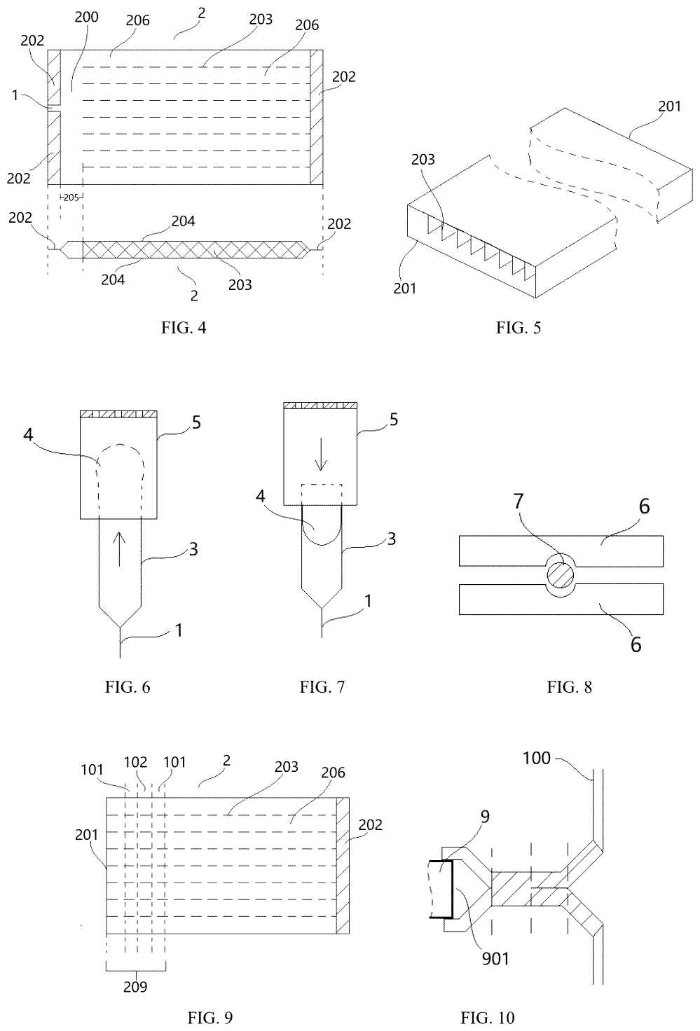

As shown in FIG. 4 and FIG. 5, the embodiment provides a polycarbonate vacuum plate, including a multilayered polycarbonate plate main body 2 and the air extraction pipeline 1 with a sealing structure. The multilayered polycarbonate plate main body 2 includes a plurality of polycarbonate plates 204, where four polycarbonate plates 204 enclose and form four faces of the multilayered polycarbonate plate main body 2, and the remaining two opening ends 201 are respectively provided with sealing portions 202. The opening ends 201 are sealed by the sealing portions 202. The sealing portion 202 of at least one opening end 201 of the multilayered polycarbonate plate main body 2 and the air extraction pipeline 1 are of an integrally formed structure.

A hollow interior of the multilayered polycarbonate plate main body 2 includes vacuum space 200, and a gas absorbent and/or a vacuum degree indicator is arranged in the vacuum space 200. Among the four faces, a plurality of spacers 203 are connected between two polycarbonate plates 204 with large areas face to face to divide the vacuum space 200 into a plurality of sub space 206. There is a spacing 205 between an end portion of each of the spacers 203 and the sealing portion 202 of the opening end 201, and the spacing 205 forms a channel connected to the spacers 203 to divide the vacuum space 200 into sub space 206. The channel is located on a side where the sealing portion 202 of the multilayered polycarbonate plate main body 2 is located, the air extraction pipeline I located on the side, so that the air extraction pipeline 1 extracts air from each sub space 206 before being sealed.

### Embodiment 3

As shown in FIG. 6 and FIG. 7, to find leakage of the hollow polycarbonate plate in embodiment 2 timely, for example, panel destroy, the embodiment provides a vacuum degree indicator.

The vacuum degree indicator includes: a hollow pipe 3, an air bag 4, and a shielding portion 5. The air bag 4 is hermetically sleeved at one end of the hollow pipe 3, the shielding portion 5 is connected to an end portion of the hollow pipe 3 where the air bag 4 is located and extends outwards axially, and the other end of the hollow pipe 3 is sealed. The hollow pipe 3 can be made of a polycarbonate material, i.e., PC material. The other end of the hollow pipe 3 can be, for example, air-extracted and sealed by way of embodiment 1 or variable embodiments of embodiment 1 in a non-limiting manner, and the other end and the air extraction pipeline 1 are of an integrally formed structure. The air pressure in the hollow pipe 3 is about 200 Pa. The shielding portion 5 is of an unsealed structure, so that the air bag 4 can be in contact with external space of the vacuum degree indicator. If there is gas in the external space, the gas in the external space is allowed to press the air bag 4.

As shown in FIG. 6, when the external air pressure is lower than the internal air pressure of the hollow pipe 3, the air bag 4 is shielded by the shielding portion 5. As shown in FIG. 7, when the external air pressure is higher than or equal to the internal air pressure of the hollow pipe 3, the air bag 4 enters the hollow pipe 3 under the action of the external air pressure and is exposed from the shielding portion 5, indicating that, for example, the polycarbonate vacuum plate has been subjected to air leakage. The air bag 4 can be set with a striking color, for example, red.

### Embodiment 4

The embodiment provides a method for preparing a polycarbonate vacuum plate, including the following steps:

Step A: an opening end 201 of a multilayered polycarbonate plate main body 2 is heated to a hot melting temperature for hot melting through a heating head, and the hot-melted opening end 201 is then extruded with a clamp, and molecular fusion and sizing are performed to wait for cooling to form a sealing portion 202. A gas absorbent and/or a vacuum degree indicator is placed inside the multilayered polycarbonate plate main body 2.

As shown in FIG. 5, in Step A, before one opening end 201 is hot-melted and sealed, spacers 203 inside the multilayered polycarbonate plate main body 2 can be milled first from the other opening end 201 of the multilayered polycarbonate plate main body 2, so that the length of each of the spacers 203 is shortened inwards by 2 cm (in an initial state, the end portion of the spacer 203 is aligned with the opening end 201) to form a channel connecting sub space divided in the multilayered polycarbonate plate main body 2 by the spacers 203, as shown in FIG. 5. Then a high pressure gas is blown into the multilayered polycarbonate plate main body 2 from the other opening end 201 to blow out fragments generated by milling from one opening end 201 to clean the multilayered polycarbonate plate main body 2. A gas adsorbent/or a vacuum degree indicator is placed inside the multilayered polycarbonate plate main body 2. After the channel is formed, as shown in FIG. 8, the multilayered polycarbonate plate main body is heated to the hot-melting temperature with the heating head at the other opening end 201 and then extruded with a slotted clamp 6, and a stainless steel cylinder 7 is placed at a slotted position to form the air extraction pipeline 1 with the channel connecting the sub space and the external space of the multilayered polycarbonate plate main body 2. The stainless steel cylinder is pulled out after waiting for cooling and sizing. In this case, the air extraction pipeline 1 is unscaled.

Step B: an air extraction pipe of vacuumizing equipment is inserted into pipelines of the air extraction pipeline 1 to vacuumize the multilayered polycarbonate plate main body 2, and an air-extracted state or a sealed state is kept according to a condition of the vacuumizer. Specifically, with respect to the vacuumizer which cannot be sealed when vacuumizing is stopped, the air-extracted state is kept; and with respect to the vacuumizer which can be scaled when vacuumizing is stopped, the sealed state is kept.

Step C: corresponding to the embodiment shown in FIG. 1, an orifice of the air extraction pipe of the vacuumizing equipment is withdrawn from the position of the first section 101, for example, withdrawn to the position of the sealing section 102 or withdrawn to a pipeline position (not shown in FIG. 1) on the side of the sealing section 102 away from the air-extracted object 100 to be inserted in the pipeline of the air extraction pipeline 1 for continuous air extraction so as to keep the air-extracted state or the sealed state; or the orifice of the air extraction pipe is located at the position of the sealing section 102 at the initial time; or the orifice of the air extraction pipe is located at the pipeline position (not shown in FIG. 1) on the side of the sealing section 102 away from the air-extracted object 100 at the initial time. The position of the first section 101 of the air extraction pipeline 1 is heated and softened with the heating head and is kept extruded and clamped with the clamp, so that inner walls of the continuously extruded portion of the air extraction pipeline 1 fit each other to form the first section 101 to temporarily close the pipeline of the air extraction pipeline 1.

The air extraction pipe 9 is pulled away from the air extraction pipeline 1, so that the inner and outer walls of the sealing section 102 are placed in atmosphere with equal air pressure. The position of the sealing section 102 is in normal air. The clamp at the position of the first section 101 applies a pressure all the time, so that air leakage is avoided. Thus, when the position of the sealing section 102 is melted, there will be no air pressure difference. Or when the vacuumizer cannot be sealed when stopping vacuumizing, the air extraction pipe 9 can also be temporarily retained in the air extraction pipeline 1. As shown in FIG. 10, the orifice of the air extraction pipe 9 is located at the pipeline position 901 on the side of the scaling section 102 away from the air-extracted object 100.

The other portion (the portion at the position of the sealing section 102) of the air extraction pipeline 1 is heated to the hot-melting temperature through the heating head for hot melting and extruding, and molecular fusion and sizing are performed to wait for cooling to form the sealing section 102, so as to permanently close the pipeline of the air extraction pipeline 1. Extrusion to the first sections 101 by the clamp is removed, the inner walls of the first sections 101 are maintained fit to each other or a gap is generated between the inner walls of the first sections 101.

Finally, vacuum is formed in the sealed polycarbonate vacuum plate, and residual gas will be further absorbed by the internal gas absorbent, so that the air density in the plate is reduced. Thermal insulating and soundproofing effects of the PC vacuum plate are very good.

Temporary sealing of the first section 101 and permanent sealing of the pipeline of the air extraction interface by the sealing section 102 both are achieved by heating and extruding the pipeline of the air extraction interface. Therefore, the outer walls of the first section 101 and the sealing section 102 each have an inwardly extruded trace, with an inwardly extruded structure. The inwardly extruded trace includes two inward sunken areas, opposite to the outer wall of the pipeline, formed by extruding both sides of the pipeline of the air extraction interface by extruding equipment, as shown in FIG. 10. Such a trace will also be clamped in a pressurized manner by the clamp to form a clamping surface, for example, two places formed opposite to the outer wall of the pipeline are flat clamping surfaces.

In the embodiment, assuming that temporary sealing is not formed through the first section 101 but continuous air extraction is tried and direct hot melting extrusion is performed to form the sealing section 102, the portion of the air extraction pipeline 1 at the position of the sealing section 102 is quite soft when reaching the hot-melting temperature and will be sucked away by the air extraction pipe and the polycarbonate vacuum plate. It can be seen that temporary scaling of the first section 101 solves the technical problem that the hot-melting position is sucked away.

Assuming that temporary sealing is not formed through the first section 101 but air extraction is tried to stop and the sealed state is kept (the air extraction pipe 9 is not pulled away from the air extraction pipeline 1) and direct hot melting extrusion is performed to form the sealing section 102, the air pressure on the inner wall side of the sealing section 102 is far less than the barometric pressure on the outer wall side, and the sealing section 102 will be pressed into the air extraction pipe 9 by the barometric pressure when being hot-melted, i.e., it is stilled sucked away by the air extraction pipe 9. However, if the sealed state is not formed when the vacuumizer stops air extraction, the atmosphere is connected to the air extraction pipe 9 through the vacuumizer, and the sealing section 102 will not be pressed into the air extraction pipe 9 by the barometric pressure when being hot-melted.

In a variable embodiment, corresponding to the embodiment shown in FIG. 1, the variation is that the positions of the first section 101 and the sealing section 102 of the air extraction pipeline I are softened and extruded first, then the first section 101 is temporarily sealed, and then the sealing section 102 is hot-melted.

In another variable embodiment, corresponding to the embodiment shown in FIG. 2, the variation is that the orifice of the air extraction pipe is withdrawn from the position of the first section 101 and is still kept at the position inserted into the air extraction pipeline 1 (not shown in FIG. 2) or the orifice of the air extraction pipe is inserted into the air extraction pipeline 1 all the time and is not inserted into the position of the first section 101 all the time to keep continuous air extraction. The positions of the first sections 101 on both sides of the sealing section 102 of the air extraction pipeline I and the position of the sealing section 102 are softened and extruded with the clamp first, so that the inner walls fit the first section 101, the sealing section 102, and the first section 101 arranged successively in FIG. 2 to form temporary sealing, and then the sealing section 102 is hot-melted (the clamp at the sealing section 102 is electrified to be heated to a set temperature); where the first sections 101 on both sides of the sealing section 102 both are temporarily sealed, there is no air pressure difference between both sides of the sealing section 102 and both sides are sealed; the hot-melted inner walls are pushed by means of the air pressure difference. The temporary sealing of the first section 101 located between the orifice position of the air extraction pipe and the sealing section 102 solves the technical problem that the hot-melting position is sucked away by the air extraction pipe. The temporary sealing of the first section 101 located between the sealing section 102 and the air-extracted object 100 solves the technical problem that the hot-melting position is sucked away by the PC vacuum plate.

In another variable embodiment, corresponding to the embodiment shown in FIG. 3, the variation is that the positions of the first section 101, the second section 103, and the sealing section 102 are softened and extruded with the clamp first, so that the inner walls fit each other, then, the position of the first section 101 is temporarily sealed, and then the sealing section 102 is hot-melted; and the temporary sealing of the first section 101 solves the technical problem that the hot-melting position is sucked away.

In the embodiment, a heating temperature of the hot-melting is higher than or equal to 160° C., and a heating temperature of the softening is higher than or equal to 130° C. and lower than or equal to 140° C.

### Embodiment 5

As shown in FIG. 9, in the embodiment, the air extraction interface is an opening section 209 of the multilayered polycarbonate plate main body 2. A component of the vacuumizer connected to the opening section 209 of the multilayered polycarbonate plate main body 2 is a vacuumizing pipe or a vacuumizing sleeve. The vacuumizing pipe can be connected to any position of the opening section 209 at the initial time of vacuumizing, preferably at a position where the first section 101 and the sealing section 102 are avoided. The vacuumizing sleeve is sleeved at the position of the opening section 209 where the first section 101 and the scaling section 102 are avoided during vacuumizing, so that the outer surface of the opening section 209 at the positions of the first section 101 and the sealing section 102 is in air all the time, which, thus, allows the heating clamp to clamp the positions of the first section 101 and the sealing section 102 in a pressurized manner.

Specifically, a method for preparing a polycarbonate vacuum plate includes the following steps:

An opening end 201 of a multilayered polycarbonate plate main body 2 is heated to a hot melting temperature for hot melting through a heating head, and the hot-melted opening end 201 is then extruded with a clamp, and molecular fusion and sizing are performed to wait for cooling to form a sealing portion 202. As the vacuum space formed by the spacers 203 of the multilayered polycarbonate plate main body 2 is not interconnected but spaced from one another in the embodiment, one vacuum space subjected to air leakage does not affect sealing of other vacuum space. Of course, as a non-limiting example, the gas absorbent and/or vacuum degree indicator can be placed in one or more vacuum space inside the multilayered polycarbonate plate main body 2.

A vacuumizing step: an air extraction mouthpiece of the vacuumizing equipment is hermetically sleeved at the other end opening 201 to vacuumize the multilayered polycarbonate plate main body 2, and the air-extracted state is kept.

A sealing step: a first portion of the opening section 209 of the other opening end 201 of the multilayered polycarbonate plate main body 2 is heated, softened, and extruded in air to make inner walls of the extruded portion of the opening section 209 continuously fit each other to form the first section 101, so as to temporarily close the pipeline of the opening section 209; a second portion of the opening end 209 is hot-melted and extruded to form the sealing section 102, to permanently close the pipeline of the opening section 209; and extrusion to the first section 101 is removed, where the inner walls of the first section 101 are maintained to fit each other or there is a gap between the inner walls of the first section 101.

In the sealing step, specifically, the positions of the first sections 101 on both sides of the sealing section 102 of the opening section 209 and the position of the sealing section 102 are softened and extruded with the clamp first, so that the inner walls fit the first section 101, the sealing section 102, and the first section 101 arranged successively in FIG. 9 to form temporary sealing, and then the sealing section 102 is hot-melted (the clamp at the sealing section 102 is electrified to be heated to a set temperature); where the first sections 101 on both sides of the sealing section 102 both are temporarily sealed, there is no air pressure difference between both sides of the sealing section 102 and both sides are sealed; the hot-melted inner walls are pushed by means of the air pressure difference. Moreover, the temporary sealing of the first section 101 located between the air extraction mouthpiece and the sealing section 102 solves the technical problem that the hot-melting position is sucked away by the air extraction mouthpiece. The temporary sealing of the first section 101 of the scaling section 102 on the side away from the air extraction mouthpiece solves the technical problem that the hot-melting position is sucked away by a negative pressure in the PC vacuum plate.

The softening the first section 101, the sealing section 102, and the first section 101 arranged successively with a constant temperature pressure head includes: softening the portions at the positions of the first section 101, the sealing section 102, and the first section 101 of the spacer 203 to achieve temporary sealing.

### Embodiment 6

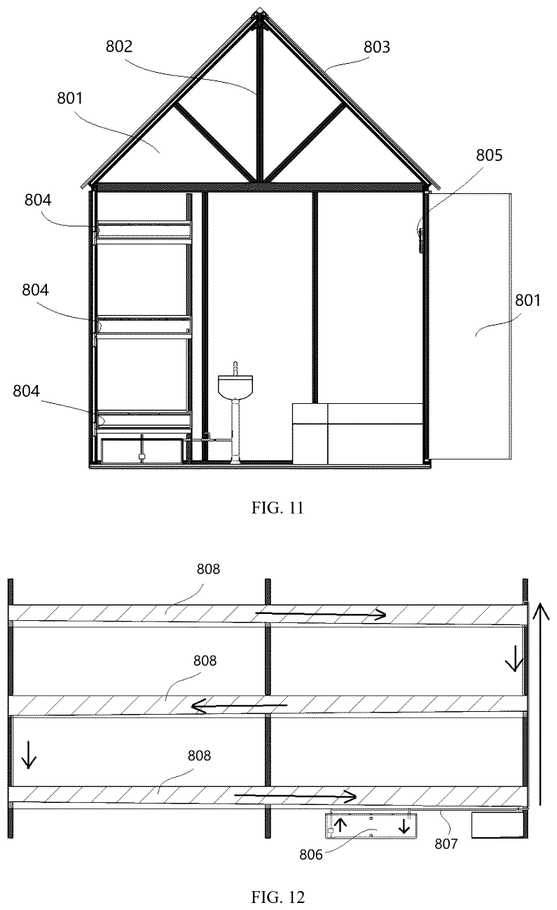

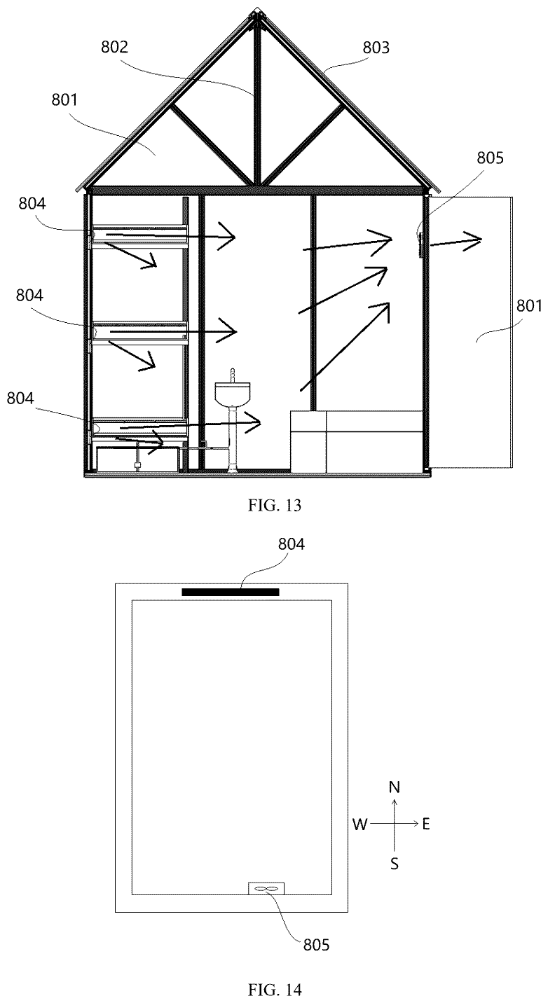

As shown in FIG. 11, the embodiment provides a sunlight room as a plant growth room, including splicable and detachable panels 801 which form closed or semi-closed plant growth space for accommodating plants; and an environmental conditioning system which controls environmental parameters in the space to facilitate plant growth. By adjusting the parameters in the closed space, the quality and output of the plants can be greatly improved. For example, vegetables are supplied to families.

The closed or semi-closed plant growth space is the sunlight room which has a floor, a roof, and walls. The sunlight room is of a transmitting structure, which can substantially satisfy illumination required by vegetable growth. The sunlight room is easily constructed without occupying large space. Any one or more of the floor, roof, and walls of the sunlight room is the polycarbonate vacuum plate.

The walls are constructed by one or more polycarbonate vacuum plates processed into suitable shapes and sizes and an aluminum section frame 802. The polycarbonate vacuum plate is good in transmission of light, which can substantially satisfy the requirement of the plants on illumination. The polycarbonate vacuum plate is light, suitable for being modularly mounted, low in cost and high in reliability, and can resist strong wind and rainy and snowy weather. The polycarbonate vacuum plate is formed by overlapping two or more layers, a gap is formed between the layers, and the vacuum space in the gap can play a thermal insulating role. There is also a cross beam perpendicular to the layers between the layers, thereby increasing the structural strength of the plate. The floor can be prepared from a plastic wooden floor, a wooden floor, a metal plate, a plastic plate, a polycarbonate vacuum plate and the like, and can be integrally formed or formed by splicing by a plurality of plates. The formed plant growth space is about 3-6 m long, 1.8-4 m wide, and 2-4 m high.

A process of constructing the closed or semi-closed plant growth space includes: a foundation is leveled; and a rectangular bottom frame is constructed on the foundation, where a height of the rectangular bottom frame is 15-25 cm, and a material thereof is a light and firm aluminum alloy. The cross beam is erected on the frame of the foundation, and the floor is paved finally on the constructed sunlight room.

Wall mounting includes: channel-like limiting grooves opened upwards are mounted on the bottom frame; the polycarbonate vacuum plate is clamped by two aluminum alloy frames; one polycarbonate vacuum plate and two aluminum alloy frames form a splicing module; two splicing modules are in meshing connection; and the channel-like limiting groove is inserted into the bottom of each of the splicing modules, and the top of each of the splicing modules is connected to a cross section groove.

The environmental conditioning system includes:
a temperature control system, configured to control the temperature in the space to facilitate vegetable growth. The temperature in the sunlight room is increased sharply at sunlight illumination, which far exceeds high temperature which can be borne by vegetable growth. At night without sunlight illumination, the temperature will be decreased to an external environmental temperature which may exceed low temperature that can be borne by vegetable growth. The difference between air temperatures in winter and summer is great, which also brings a huge difficulty to temperature adjustment of the sunlight room. The plant growth system provided by the present invention adjusts the temperature in many ways. When it is needed to increase or decrease the temperature, temperature adjustment includes adjusting the overall temperature in the space and adjusting the temperature of a nutrient solution flowing through the roots of the plants. It is also to be noted that illumination required by plant growth and corresponding humidity are guaranteed to fit plant growth while the temperature is adjusted.

The environmental conditioning system further includes: an irrigation control system, configured to control the nutrient solution at the roots of the vegetables and/or the irrigation duration and irrigation frequency of water to facilitate vegetable growth, where different plants need different irrigation strategies, and the irrigation strategies are also adjusted in real time according to condition changes of illumination, temperature, and humidity;
an illumination control system, configured to control illumination irradiated to the vegetables to facilitate vegetable growth, including sunshading and light supplementing as needed, where the illumination control system in the present invention can be linked with the temperature control system;
a gas control system, configured to control humidity, oxygen, and carbon dioxide concentration in the space to facilitate vegetable growth, where the humidity, oxygen, and carbon dioxide concentration will affect photosynthesis and respiratory action of the plants, and the gas control system needs to monitor and control the humidity, oxygen, and carbon dioxide concentration in real time; and
a nutrient solution control system, configured to control element concentrations in the nutrient solution irrigated to the roots of the vegetables to facilitate vegetable growth. The element concentrations needed by different vegetables are different, and thus, the nutrient solution control system needs to control nutrient solution preparation of different vegetables.

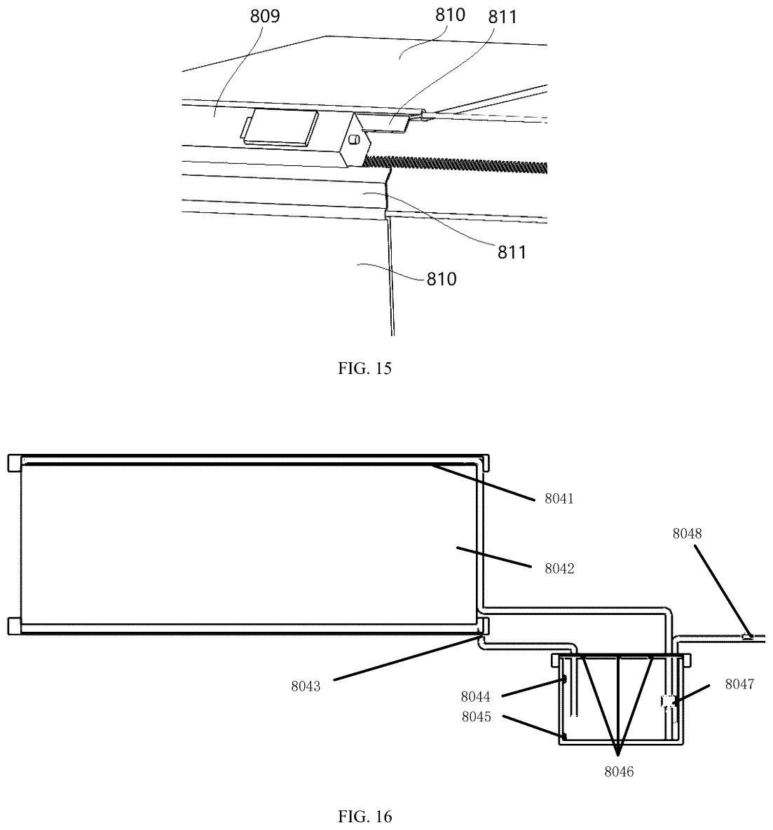

The temperature control system includes one or more of the following:
a first illumination adjusting apparatus, configured to adjust areas at which natural sunlight projected at a top and a side surface of the plant growth space are shielded. As shown in FIG. 15, an abat vent can be used to shield illumination in real time, and in summer, the abat vent can decrease the temperature in the sunlight room immediately. The abat vent 803 can be driven by a motor with a high degree of automation. When the temperature is too high, the abat vent can operate automatically according to an instruction of the temperature control system. Besides, the abat vent 803 can control the shielding area randomly, so that the temperature adjusting flexibility is high. A curtain material of the abat vent 803 can be a sunlight fabric, which can effectively prevent infrared rays from passing through, thereby achieving better cooling. The first illumination adjusting device includes the abat vent capable of covering the roof of the sunlight room. The abat vent 803 includes a track, a motor driven apparatus 809, a pull rod arm 811, and a curtain 810. The track is arranged on the roof of the sunlight room. A bottom surface of the track and a ridge are fixed or fused integrally. The track can be either of an upper cover structure and a lower cover structure or I steel to limit the operating direction of the motor and prevent the motor and other rotating structures from being invaded by wind and rain; the motor driven apparatus includes a motor and a gearing-down apparatus; the pull rod arm is fixedly connected to the motor driven apparatus, and is driven by a driving apparatus to move left and right along the track; slidable circular rings are mounted at upper and lower edges of the curtain, the circular rings are sleeved on two curtain tracks parallel to the track, the left side of the curtain is fixedly connected to a roof beam on the left side, the right side of the curtain is connected to the pull rod arm, and the pull rod arm moves left and right to drive the curtain to move left and right, so as to satisfy a sunshading requirement on the sunlight room. In the first embodiment, a spring applies a pressure, so that the track and a motor driven wheel generate a frictional force. Thus, the motor driven wheel can roll relative to the track, which achieves movement of the driving apparatus. In the second embodiment, the wheel can be replaced with a gear. The track is internally provided with a rack. The gear and the rack are meshed to generate a frictional force, so that the motor can operate relative to the track. Both sides of the motor are respectively connected to two wing structure, and the pull rod arm slides to unfold or fold the sunshade cloth. Further, a motor can also be selected and fixed to one end or each of both ends of the track, a chain structure is arranged in the track, the motor drives a chain to rotate, and the chain drives the two wing structure pull rod arms to slide. Each of the wing structure pull rod arms is provided with a sliding limiting track, including an upper end curtain track connected at a certain height of two gable walls. A tail end of an cave extends outward at a certain distance. Tail ends of both ends of the roof extend certain distances. A tail end where the two extended sections is provided with a tail end curtain track. A wing tail end is provided with a limiting ring sleeved at the tail end curtain track.

The temperature control system further includes a second illumination adjusting apparatus, configured to provide a light source directly illuminated inside the space. A fill light can be used as a supplementary light source in winter lack of sunlight or on cloudy and rainy days. When the fill light is turned on for illumination, heat will be generated as a heat source for heating the space. A proper fill light amount of the fill light can be achieved by adjusting a fill light duration or a light intensity of the fill light. When leafy vegetables are planted in multilayered overlapped platform type planting troughs, the fill lights are uniformly mounted on bottom surfaces of the planting troughs. The fill lights on the bottom surface of the previous planting trough are aligned with leafy vegetables in the next planting trough to achieve a light supplementing effect. The leafy vegetables in the uppermost layer can absorb maximum illumination, and thus, light supplementation is not needed. With respect to fruity vegetables and vertically planted leafy vegetables, the fill lights can be fixedly mounted on aluminum alloy sections on walls of the sunlight room or on a truss connected between the gable walls or roofs of the sunlight room. The specific positions are set to achieve the following condition: vegetables within 0.2-1 m can be directly irradiated.

The temperature control system further includes a first ventilating apparatus, configured to adjust an air power source and to provide an air pressure difference between the inside and outside of the space by sucking or exhausting air in the space. As shown in FIG. 12, for example, 2-8 fans 805 are arranged at an interval at a certain height of a south wall or 1 fan 805 is arranged. An air circulation path can be formed with the second ventilating apparatus and/or the first water circulating apparatus at the height, for example 200 cm. A baffle is mounted outside the fan 805 to prevent cold air in winter from entering the sunlight room through gaps of the fan to cause a low temperature. An electromagnet apparatus is mounted on the baffle. When the electromagnet is electrified, the baffle can be actuated with the wall of the sunlight room to close. When the electromagnet is interrupted, air exhausted from the fan breaks through the baffle to form an air runner. In the actuated closed state, the baffle and the vertical plane form an included angle which is 5-30 degrees, such as 5, 10, 15, 20, 25, and 30 degrees. Mounting positions of the fans 805 are diverse, including walls, gable walls, roofs and the like. To facilitate operation, the fans are mounted on the walls or gable walls best, and for example, 2-8 exhaust fans are arranged at an interval at a certain height of the west wall or south wall or west gable wall (higher than 20 cm to prevent objects such as ground viruses from being sucked) or 1 fan 805 is arranged. Since the exhaust fans generate negative pressures, the air flow in the sunlight room is from north to south or from east to west. In this case, a facility capable of introducing external air is arranged on the north wall or cast wall. Since ventilation of the sunlight room mainly aims to cooling, an effect of filling hot air with cold air can be achieved, i.e., an effect that air flows from a cold area to a hot area till it is exhausted out of the sunlight room.

The temperature control system further includes a second ventilating apparatus, configured to adjust a contact area where air circulates freely between the inside and outside of the space. For example, 1-2 skylights are arranged at an interval at a certain height of a north roof, and the skylights are driven by a motor to adjust the opening angles of the skylights. Set positions can match other equipment such as the fans and air inlets and outlets, or the skylights are arranged on the west gable wall or the south wall. The set positions can match other equipment such as the fans 805 and the water curtain 804. The skylights are driven by the motor to adjust the opening angles of the skylights.

The temperature control system further includes a first water circulating apparatus, configured to adjust temperature and humidity in the space and to exchange air with the outside. The first water circulating apparatus includes the water curtain and a mask. As shown in FIGS. 14 and 16, the water curtain 804 mounted on the north wall is a semi-closed heat exchanging ventilating apparatus mounted on the polycarbonate vacuum plate. A water pump is started according to the need to adjust the temperature and humidity, and a collecting tank supplies water to a water spray pipe. The water spray pipe is arranged at the top of the water curtain 804. Water flowing from the water spray pipe is distributed on the surface of a high polymer material layer. The high polymer material layer uses kraft paper or other high polymer material layers. When there is the air pressure between inside and outside of the sunlight room, air flows, so that water on the surface of the kraft paper is evaporated to take away a lot of heat to achieve a cooling purpose. The water flowing from the kraft paper finally flows into the collecting tank, and UVC sterilization and disinfection is mounted in the collecting tank. A hollowed sectioned notch is formed in the north wall. The water curtain 804 is embedded into the hollowed sectioned notch. The aluminum alloy frame is mounted on the hollowed sectioned notch, so that the weight of the water curtain can be borne by the frame. The mask covers the sectioned notch from outside to seal the water curtain 804, and external air is prevented from entering the sunlight room from the water curtain when the water curtain needs to be scaled; or, the mask covers the sectioned notch from inside to seal the water curtain. The water curtain includes a top water spray pipe, a bottom recovery apparatus, and an opened heat exchanging ventilating apparatus. A basic material of the heat exchanging ventilating apparatus is the kraft paper or high polymer material, and a basic structure is cellular. The kraft paper or high polymer material is a rectangular paper slip in a curved wave shape. The length direction is perpendicular to the ground, and the width direction is perpendicular to the wall. A plurality of small holes are formed by waves between two layers of kraft paper or high polymer materials, so that a cellular structure is formed. A water flow flowing from the top water spray pipe falls naturally and flows through the heat exchanging ventilating apparatus. Since the fans mounted opposite to the water curtain provide the spatial negative pressures, air outside the space will enter the space through the heat exchanging ventilating apparatus, and flows through the heat exchanging ventilating apparatus to gasify water, so as to take away heat in the air. The bottom recovery apparatus is a water channel at a slightly inclined angle and collects drippy water in a water tank for cyclic utilization. When a water level sensor detects that the water level of the water tank is lower than an alarm value, the electromagnetic valve is opened automatically for supplementing water. A sterilizing UVC LED lamp is further mounted in the water channel to disinfect viruses and bacteria in the water channel. The structure of the curtain water is basically fused with the sunlight room together. In the embodiment, the area and air quantity of the water curtain are controlled, so that the speed of wind flowing through the water curtain reaches 1-3 m/s, and humidity and temperature reach a reasonable state. The water curtain is mounted on the north wall, and the fans are mounted on the south wall to form a convection loop, so that air in the whole sunlight room flows uniformly. Or, the water curtain is mounted on the cast wall, and the exhaust fans are mounted on the west wall to form a convection loop, so that air in the whole sunlight room flows. In terms of quantity, 2 or 3 water curtain can be arranged from top to bottom, and 2 or 3 rows of fans can also be arranged, so that temperature and humidity in the room are uniformly distributed.

More specifically, it is shown in FIG. 16.

The water pump 8047 pumps disinfected water from the water tank with the UVC sterilizing lamp 8046 to a top water pipe located above the multilayered kraft paper layer 8042. Water leaks in the multilayered kraft paper layer 8042 from a hole 8041 of the top water pipe. When blowing the multilayered kraft paper layer 8042, wind drives water molecules of the moist multilayered kraft paper layer 8042 to enter the internal space of the sunlight room where plants are distributed, thereby achieving an effect of cooling and humidifying the internal space. Then, water flows to a collecting water pipe 8043 at bottom through the multilayered kraft paper layer 8042 and flows into the water tank after being collected. A high water level sensor 8044 and a low water level sensor 8045 are arranged in the water tank. When a high water level is detected, the electromagnetic valve is controlled to be closed to stop adding water, and when a low water level is detected, the electromagnetic valve is controlled to be opened to add water.

The temperature control system further includes a second water circulating apparatus with, for example, a pray head arranged at the top of the space, capable of directly spraying clean water into the space periodically or according to requirements on temperature and humidity. The spray head can include a spraying apparatus connected to a ground delivery pipe. The spraying apparatus includes a high pressure water pump and a sprinkler head. A high pressure water pump pumps the clean water to the sprinkler head at the roof in the sunlight room to form aerial fog, so as to achieve cooling and humidifying purposes. The spray head can be connected to/branch a water supply pipe of the water curtain.

The temperature control system further includes a third water circulating apparatus, configured to transfer head between air and soil through an underground water circulating system, thereby achieving heat exchange of air in the sunlight room and underground soil. The third water circulating apparatus includes a liquid storage tank, configured to store clean water; a fluid pipeline, configured to deliver the clean water to the PC plate of the sunlight room and make the clean water return to the liquid storage tank; and an underground heat exchanger, configured to exchange heat between the clean water flowing through the heat exchanger and the underground soil or liquid wrapping the heat exchanger; the fluid pipeline includes an underground delivery pipeline, an overground delivery pipe, an overground returning pipeline, and an underground returning pipeline, where the underground heat exchanger can make the temperature difference between the temperature of the clean water therein and the underground soil or liquid less than 1 degrees Celsius. The heat exchanger is located at a depth 200 cm underground, there is a large difference value between surrounding soil and environmental temperature, and it is warm in winter and cool in summer.

The illumination control system includes the first illumination adjusting apparatus and the second illumination adjusting apparatus.

The gas control system includes the first ventilating apparatus, the second ventilating apparatus, and the first water circulating apparatus.

A plant culture method provided by the embodiment includes one or more of the following:

An aerial fog culture method can be used, i.e., a plant growth stand is erected. For example, a plurality of holes are formed in a slope, wall space or an inverted V-shaped support. Plants pass through the holes, with roots exposed to the side of the slope facing the ground, or the backlit side of the wall space, or inside the inverted V-shaped support, and leaves or fruits exposed to the side facing the sunlight. A nutrient solution is delivered to the pressurizing spray head of the high pressure pump through a delivery pipe, and the spray head is arranged at a position just to spray nutrient solution aerial fog to the roots of the plants. The method can provide the roots with good configuration of fertilizers, water, and oxygen. Oxygen is fully dissolved in the nutrient solution, and the nutrient solution and air are fully mixed, so that the tolerance of the roots of the plants to the environmental temperature is high, and thus, the quality and output of the plants are greatly improved. However, the spray head is easily blocked by impurities (a nutrient solution precipitate, organic matters flushed, and the like), which causes a locked-rotor effect of the motor, resulting in burning of the motor. Therefore, the high pressure water pump is short in life. In addition, since the spray heads need to be mounted at an interval to uniformly spray and irrigate the roots of the plants, and a delivery pipe is further needed to be paved, so that the whole apparatus is mounted in a relatively complicated manner. Moreover, the inside closed space of the inverted V-shaped support is large, which is likely to raise the temperature in the space under sunlight illumination. To overcome the problem, a light-colored plant growth stand can be used. In addition, each growth stand occupies certain space independently, so that high density planting cannot be achieved.

A water culture method can also be used, i.e., the roots of the plants are immersed in the nutrient solution. The method is easy to control, the irrigating apparatus is simple and low in cost, but the tolerance to the temperature and the nutrient solution concentration is lower than that in aerial fog cultivation. A multilayered petaloid plant stand is one of the water culture methods, which has the defect that mycetes are easily generated at the roots of the plants, resulting in rot of the roots of the plants. The plant stand is a hollow cylinder. The hollow cylindrical space is provided with the delivery pipe from top to bottom. The nutrient solution is delivered by the delivery pipe from bottom to top to the top end of the cylinder. Under the gravity action, the nutrient solution naturally drips to the roots of the plants in the cylinder. Plant stems and leaves grow on an outer side surface of the cylinder.

A matrix culture method can also be used, i.e., the roots of the plants are planted in a matrix of a growth tank, and the matrix is infiltrated with the nutrient solution. The matrix can be coco coir, ceramsite and the like. The coco coir is good in temperature release to prevent rapid temperature variation of the roots of the plants. Besides, the coco coir is low in transportation cost, and coco coir blocks which are not soaked can be transported and stored, and are then soaked during use to expand by 4 times. However, soaking of the coco coir will generate sewage, so that waste needs to be treated. The method can alleviate volatilization of the nutrient solution, and is easy to insulate and complex to treat the matrix. The growth tank is rectangular. Water pumps are arranged at certain intervals for drop irrigation of the nutrient solution to the coco coir. The temperature release of the ceramsite is slightly poorer than that of the coco coir, and the ceramsite cannot be soaked, so that the transportation cost is high. But the ceramsite is relatively clean and do not generate sewage, which are also a good matrix for soilless culture.

An ebb and flow irrigation method can also be used, i.e., the roots of the plants are immersed in the nutrient solution, and the nutrient solution is exhausted in certain time. According to the method, mycetes are not easily bred in the plants.

In the water culture method and the ebb and flow irrigation method, the roots of the plants can be placed in perlite and/or ceramsite, a growth plate can also be fixedly placed at an upper edge of the plant growth tank, holes are formed in the growth plate, the plants pass through the holes with the roots facing downwards and the leaves facing upwards, the roots fall naturally in the plant growth tank, each plant can be planted in a growth cup, the growth cup passes through each of the holes with an opening facing upwards, and the lower diameter of the growth cup is less than the pore and the upper diameter thereof is greater than the pore, so that the growth cup is buckled and suspended in the pore of the growth plate.

As shown in FIG. 12, the irrigation control system includes one or more of the following:

A first irrigating apparatus 808, configured in a trough shape, located on the north side and/or the west side of the sunlight room, and configured to culture leafy vegetables and grow seedlings with the water culture method or the ebb and flow irrigation method, where a plurality of first irrigating apparatuses can be arranged in a cascaded manner, for example, a plurality of triangular support frames are transversely arranged on the wall, a bearing batten is fixed on each of the triangular support frame, each of the first irrigating apparatuses is placed on the bearing batten, and bearing battens are respectively arranged on the wall at heights 0 cm, 75 cm, and 150 cm, so that high density planting is achieved. Bearing battens can also be respectively arranged on the wall at heights 40 cm, 110 cm, and 180 cm.

The irrigation control system further includes a second irrigating apparatus, configured in a columnar shape and located in the middle of the plant growth space, where a plurality of layers of petaloid grooves are stacked axially to accommodate plants, or holes extend radially where leaves of the plants stretch, roots of the plants are left inside a column shaft, and the system can be used in the ebb and flow irrigation method (the system calculates time, the water pumps deliver the nutrient solution to the top of the column shaft, and the nutrient solution flows through the petaloid grooves layer by layer to the bottom and flows back to the nutrient solution pool); and

A third irrigating apparatus, configured in a trough shape, located on the east or west side of the sunlight room, and configured to accommodate the matrix infiltrated by the nutrient solution, for example, coco coir for planting fruity vegetables, where the plants climb vines from a climbing frame suspended on the cross beam of the roof to the third irrigating apparatus.

The nutrient control system includes:
nutrient tanks, i.e., the nutrient solution pools 806, mounted on a floor of the sunlight room; each of the nutrient tanks is cuboid water channels, the surface of which is formed by a baggy structure formed by double-layered soft skin made of a PVC material, and four corners at the bottom are fixed to form the bottom of the water channel; the nutrient tank is placed on the floor under each plant planting area, the baggy structure by the double-layered soft skin made of the PVC material inflates a gap between the double-layered soft skin, the double-layered soft skin expands to form a pool with the bottom surface being a plane, and when not inflated, the double-layered soft skin can be curled to form a ball or a column, so that the mounting and transportation costs are low; or the water channel is formed by a plurality of connected foldable panels, where a baggy structure is formed by the double-layered soft skin made of the PVC material, the PVC hollow plates are flatly placed between the double-layered soft skin, the PVC plates are adhered together through the double-layered skin and are isolated from each other; this structure features a thermal insulating effect, and the water channel can be folded, so that the mounting and transportation costs are lowered. Each type of plants can correspond to one nutrient pool to achieve the optimum nutrient proportion of different plants.

The nutrient control system further includes: fertilizing solution pools, mounted on a north wall of the sunlight room, located above the floor and not shielded, and convenient for the user to prepare element fertilizers, where the user can be prevented from stooping to fertilize the nutrient solution pools below the plant stand during fertilization, and can stir fertilizers in inter-platform basins and pour the fertilizers into the nutrient solution pools. The fertilizing solution pool is a water channel opened upwards, the one fertilizing solution pool is provided with an irrigating apparatus connected to the nutrient solution pool through a water pipe, and the nutrient solution pool is provided with a stirring apparatus to prompt the fertilizers or a waste solution to be dissolved in water. The irrigating apparatus is configured to blend the liquid in the fertilizing solution pool into the nutrient solution pool.

The user can be provided with three types of containers containing fertilizers, for example, packages and bottles, respectively marked as a fertilizer package A, a fertilizer package B, and a fertilizer bottle C, where the fertilizers in each fertilizer container are chemically nonreactive, there are macro element or medium element solid compounds in the fertilizer bag A, there are macro element or medium element solid compounds in the fertilizer bag B, and there are trace element liquid compounds in the fertilizer bottle C, and since a small mass of trace element liquid compounds is needed and hardly weighed, the trace element liquid compounds are dissolved in water and stored in the fertilizer bottle C. The elements needed by various vegetables in the three fertilizers in the fertilizer package A, the fertilizer package B, and the fertilizer bottle C are prepared strictly in proportion, where the quantity of the fertilizers ABC provided to the user is calculated strictly according to fertilizing volume per time, and the amount of fertilizer added once is just one fertilizer bag A, one fertilizer bag B, and one fertilizer bottle C; and fertilizers in the fertilizer bag A. The fertilizer package A, the fertilizer package B, and the fertilizer bottle Care respectively dissolved in water and then flow into the nutrient solution pools through the fertilizing solution pools.

There may be a plurality of fertilizing solution pools, a plurality of water pipes arc arranged at the bottom of the water channel, the water pipes are controlled to connect and close by water valves, respectively, and each of the water pipes is connected to one nutrient solution pool. When the nutrient solution is prepared, different fertilizers can be imported according to different plant requirements, then clean water is discharged into the fertilizing solution pools to mix and stir the fertilizers, and after the fertilizers are dissolved, and a water pipe switch connected to the nutrient solution pool corresponding to the plant is switched on to add the fertilizer solution to the nutrient solution pool.

In a preferred embodiment, different fertilizers are poured into different measuring glass, water is added into the measuring glass to be uniformly stirred, a mixture is poured into the fertilizing pools, and corresponding water valves are opened to import the mixture into corresponding nutrient solution pools, and then some clean water is released to clean the fertilizing pools, and then the mixture is imported into the corresponding nutrient solution pools. The reason why stirring is not performed in the fertilizing pools is that a condition that the solid fertilizers entering the pools cannot be fully dissolved in the gaps is avoided as the shape of the inner wall of the fertilizing pools is irregular.

The nutrient control system further includes: delivery pipelines 807, respectively connected to the nutrient solution pools 806 to deliver nutrient solution to the roots of the plants.

Within the plant growth room, a plurality of layers of first irrigating apparatuses can be arranged on the southeast side for planting sprouting vegetables and leafy vegetables, the third irrigating apparatus can be arranged on the north side for irrigating fruity vegetables, and the second irrigating apparatus can be placed in the middle for planting leafy vegetables. The water curtain is arranged on the north wall, the skylights are arranged on the north roof, the fans are arranged on the south wall, the abat vent is arranged on the roof, the fill lights and spray heads are arranged on the roof, the nutrient solution pools for different plants are arranged on the floor, a door is arranged on the west wall, the liquid storage tank is arranged at the northwest corner, and an operating board or a storage rack is arranged at the southwest corner. Positions of all irrigation modes in the room can be adjusted freely.

The first irrigating apparatus 808 is a cuboid water channel and the water channel is formed by a plurality of connected foldable panels, where a baggy structure is formed by the double-layered soft skin made of the PVC material, the PVC hollow plates are flatly placed between the double-layered soft skin, the PVC plates are adhered together through the double-layered skin and are isolated from each other; the PVC material and structure feature a thermal insulating effect, and the water channel can be folded, so that the mounting and transportation costs are lowered.

The nutrient solution pool 806 feeds water to the first irrigating apparatus 808 at the top through the water pump, the first irrigating apparatus 808 is obliquely arranged, and the first irrigating apparatus 808 is provided with a negative pressure closed drainage apparatus, including an inverted U-shaped negative pressure accommodation cavity, where a drainage pipe opened upwards is arranged inside the cavity, a bottom end of the inverted U-shaped negative pressure accommodation cavity is provided with a derange port, and the height of the drainage pipe is decided by water retention time. The nutrient solution flowing into the first irrigating apparatus 808 at the top flows to the tail end in the inclined direction of the first irrigating apparatus 808, and is drained to the first irrigating apparatus 808 in the next layer through the pipeline at the tail end, and this cycle is repeated till the nutrient solution returns to the nutrient solution pool 806.

A top edge of the water channel is provided with a slot, the planting plate covers the water channel and is placed on the slot, the planting plate is provided with a hole, a planting cup is inserted into the hole, the roots of the plants in the planting cup are scattered in the water channel, and the depth of the water channel is 0.5-20 cm. The side surface of the planting cup is not closed where the plants grow freely.

All fertilizers are divided into three types in the embodiment, two of which are macro or medium element compounds and the other is micro element compounds. Distribution of macro elements means that chemically nonreactive compounds are divided into two fertilizers. Required fertilizer amounts are calculated according to the size of the nutrient solution pool, and the fertilizers are respectively packaged in the form of solids in two small packages: A and B. The third fertilizer means that micro elements which are too small in amount are extremely difficult to weigh, and are dissolved in water; the micro elements are taken out according to the size of the nutrient solution pool and the dosage proportion; then the required PH value is calculated; and a certain amount of acid is added into the mixture, and the mixture is packaged in a bag to obtain the fertilizer C. There are totally three fertilizer bags: A, B, and C.

Compared with a mode of all solids, in the mode of two solids with one liquid, the accuracy of nutrient substances is greatly improved. Compared with a mode where the nutrient substances all are liquids, the volume and weight are greatly reduced. According to experiments, the configuration mode of such nutrient solution fully satisfies the requirements on vegetable growth.

A proper temperature range for growth of most vegetables is 10-28° C. The temperature in the closed sunlight room without a heating measure at night substantially approaches to outdoor temperature. The temperature of the closed sunlight room radiated by the sun is easily 20-30° C. higher than the outdoor temperature in daytime. Temperature adjustment has a bearing on success or failure of vegetable growth. To exhaust indoor hot air outdoors only with exhaust fans, the cooling effect is not so good. On this basis, preferably, the abat vent is additionally arranged in the embodiment, finding that the solution greatly shortens the illumination time while improving the cooling effect, and the output of vegetables is obviously reduced; moreover, the indoor temperature is still not lower than the outdoor temperature, so that the indoor temperature in high-temperature weather is still not suitable for vegetable growth; on this basis, preferably, the water curtain is additionally arranged, water on the water curtain is vaporized by wind to take away a lot of heat, thus, reducing the indoor temperature by more than 10 degrees Celsius to the maximum extent compared with the outdoor temperature; the three match to reduce the temperature in the sunlight room on the premise of satisfying the maximum probable illumination in the sunlight room. If it is needed to increase the temperature in the sunlight room, a resistance wire is used to warm. Preferably, a certain humidity requirement is satisfied while the temperature is satisfied in the embodiment, which further facilitates a proper condition for vegetable growth. Verified by repeated experiments on environmental linked regulation from winter to summer and from summer to winter, a comprehensive adjusting method with the water curtain, the fans, the abat vent, and the indoor resistance wire heating is used in the embodiment to control the temperature and humidity in the sunlight room within a reasonable interval all the year round with low cost effectively. A humidity VPD=0.61078×exp(17.27×Ta/(Ta+237.3))×(1−RH) numerical value obtained therefrom is controlled within a range of 0.8-1.2 suitable for vegetable growth. Ta represents the environmental temperature, with a unit of degree Celsius, and RH represents relative humidity. When the value of VDP is 0.8-1.2, it is the interval where vegetables grow well.

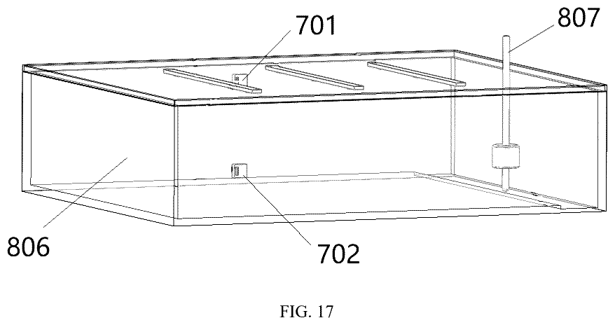

As shown in FIG. 17, the present invention further provides a fertilizer preparing and fertilizing system for a sunlight room, where the fertilizer preparing and fertilizing system includes:
a low liquid level sensor 702, disposed at a low liquid level position arranged within each of the nutrient solution pools 806;
a high liquid level sensor 701, disposed at a high liquid level position arranged within each of the nutrient solution pools 806;
a controller, electrically connected to the low liquid level sensor and the high liquid level sensor respectively and configured to open a tap water valve to add a preset amount of water into the nutrient solution pool 806 when the low liquid level sensor detects that a liquid level of the nutrient solution pool 806 is lower than a first preset position and to send a fertilization alarm signal to a mobile terminal, and to open the tap water valve to add water into the nutrient solution pool 806 and to stir the mixture when a fertilization completion signal of the mobile terminal is received till the high liquid level sensor detects that the liquid level of the nutrient solution pool 806 arrives at a second preset position; and
the mobile terminal, configured to prompt a user with a fertilizer needed to be added and to provide an operation completion button of a corresponding fertilizer when the fertilization alarm signal is received, and to send the fertilization completion signal to the controller when the operation completion buttons of all fertilizers are triggered.

The present invention further provides a fertilizer preparing and fertilizing method for a sunlight room, where the fertilizer preparing and fertilizing method includes:
Step S1: in a case that the low liquid level sensor detects that the liquid level of the nutrient solution pool 806 is lower than the first preset position, the tap water valve is opened to add the preset amount of water into the nutrient solution pool 806 and to send a fertilization alarm signal;
Step S2: a user is prompted with the fertilizers needed to be added;
Step S3: corresponding fertilizer packages are opened according to the fertilizers needed to be added respectively and poured into measuring glass, and water is added into the measuring glass to be stirred with the fertilizers, and the mixture is delivered to the nutrient solution pool 806;
Step S4: the tap water valve is opened to add water into the nutrient solution pool 806 after fertilization is completed till the high liquid level sensor detects that the liquid level of the nutrient solution pool 806 reaches the second preset position; and
Step S5: stirring is stopped after the mixture is stirred for preset time.

After fertilization is completed, the nutrient solution can be inputted into the delivery pipeline 807 through the water pumps and is transmitted to the roots of the plants.

The whole nutrient solution preparation process includes the following several elements: the fertilizer packages, the fertilizing pools and the valve pipelines, an APP, and the control system.

Taking a fertilization process of leafy vegetables as an example:
1. In a case that the low liquid level sensor in the leafy vegetable nutrient solution pool detects that the nutrient solution is short, the system sends an alarm signal through the APP to inform the user that “the leafy vegetables need fertilization”, and meanwhile, the system automatically opens the tap water electromagnetic valve to add a certain amount of tap water (water is added as long as the nutrient solution is short to ensure that the leafy vegetables can be irrigated, and in this case, the concentration of the nutrient solution is low, the leafy vegetables will grow slowly continuously, and thus, the leafy vegetables will grow normally slowly without adding the fertilizers even if the user does not fertilize the vegetables for long time due to some reasons; and if water is not added, the leafy vegetables which are not irrigated will die within certain time);
2. When the user starts fertilization in the sunlight room, he/she clicks on “leafy vegetable fertilization” of the APP, the APP prompts “add fertilizer A for leafy vegetables”, the user opens the fertilizer package A and pours it into the measuring glass (there may be solids not dissolved as the fertilizer is not stirred conveniently in the fertilizing pool), adds water to stir till the fertilizer A is fused and the mixture is poured into the fertilizer preparation pool; the user opens the leafy vegetable valve, and the fertilizer A flows into the nutrient solution pool; the user closes the leafy vegetable valve and open the tap water valve to clean the fertilizer preparation pool, the user opens the leafy vegetable valve and put a cleaning solution in the leafy vegetable nutrient solution pool, and closes the leafy vegetable valve; the user clicks on “completion of fertilization of fertilizer A for leafy vegetables”, the system opens the tap water electromagnetic valve for the leafy vegetable nutrient solution to add water to dilute the nutrient solution continuously;
3. The fertilizers B and C are added by a similar method, after addition, the APP displays “completion of fertilization for leafy vegetables”, and the alarm signal “leafy vegetables need fertilization” disappears; the system adds tap water continuously till the high liquid level sensor in the nutrient solution pool detects that the nutrient solution is full, and the tap water electromagnetic valve for leafy vegetables is closed; the control system opens the tap water stirring pump for leafy vegetables, stops stirring after stirring for certain time (certain time is needed to fully dissolve the fertilizers), and fertilization for leafy vegetables is completed;
4. The fertilizing pools are located at positions higher than the nutrient solution pools, such as walls, with several valves leading to the nutrient solution pools; they have the following advantages: the user can be prevented from stooping to fertilize the nutrient solution pools below the plant stand during fertilization, and it is inconvenient to open the cover heads of the nutrient solution pools; and
5. A and B are medium and macro element solid fertilizers, and C is the micro element liquid fertilizer; the fertilizers have the following advantages: the fertilizers are lightest, have the minimum volume, are most accurate, and are most convenient for the user to add (the fertilizers are not weighed, and 3 small packages are directly used).

In description of the application, it should be understood that orientation or position relationships indicated by terms: “upper”, “lower”, “front”, “back”, “left”, “right”, “vertical”, “horizontal”, “top”, “bottom”, “inner”, “outer” and the like are orientation or position relationships indicated by the drawings and are only to describe the disclosure and simplify the description rather than indicates or implies that the indicated device or components must have specific orientations and are configured and operated in the specific orientations. Therefore, it cannot be construed as limitations to the application.

Specific embodiments of the present invention are described above. It is needed to understand that the present invention is not limited to the specific embodiments, and those skilled in the art can made various variations or modifications within the scope of the claims without affecting the substantial contents of the present invention. In the absence of conflict, the embodiments of the application and features in the embodiments can be combined with one another arbitrarily.

1. An air extraction interface with a sealing structure, wherein the air extraction interface is an air extraction pipeline or an opening section;
an end of the air extraction interface is connected to an air-extracted object, and the sealing structure comprises a first section located at the air extraction interface and a sealing section;
inner walls of pipelines of the air extraction interface where the first section is located fit each other or there is a gap between the inner walls;
a pipeline of the air extraction interface is closed at a position where the sealing section is located;
in an extension direction of the air extraction interface, one or more first sections are located on a first side of the sealing section, wherein the first side of the sealing section is adjacent to the air-extracted object; and
one or more first sections are located on a second side of the sealing section, wherein the second side of the sealing section is away from the air-extracted object; or none of the first sections is located on the second side of the sealing section.

2. The air extraction interface with the sealing structure according to claim 1, wherein a material of the air extraction interface is polycarbonate;
the first section made of polycarbonate is an extruded portion allowed to be formed by heating and softening the air extraction interface;
the sealing section made of polycarbonate is a portion allowed to be formed by hot-melting the air extraction interface; and
a length of the first section in the extension direction of the air extraction interface is greater than or equal to 1 mm, and a length of the sealing section in the extension direction of the air extraction interface is greater than or equal to 1 mm.

3. The air extraction interface with the sealing structure according to claim 1, wherein the sealing structure further comprises a second section located at the air extraction interface;
in the extension direction of the air extraction interface, the second section is located between the first section and the sealing section face to face, and heat resistance is formed between the first section and the sealing section in heat processing;
in the extension direction of the air extraction interface, a length of the second section is greater than or equal to 1 mm;
inner walls of pipelines of the air extraction interface where the second section is located fit each other or there is a gap or a cavity between the inner walls; and
the second section made of polycarbonate is an extruded portion allowed to be formed by heating and softening the air extraction interface.

4. A polycarbonate vacuum plate, comprising a multilayered polycarbonate plate main body and the air extraction interface with the sealing structure according to claim 1;
wherein a hollow interior of the multilayered polycarbonate plate main body comprises a vacuum space; and
a sealing portion of at least one opening end of the multilayered polycarbonate plate main body and the air extraction pipeline of the air extraction interface with the sealing structure according to claim 1 are of an integrally formed structure; or a portion of the multilayered polycarbonate plate main body serves as the opening section of the air extraction interface with the sealing structure according to claim 1.

5. The polycarbonate vacuum plate according to claim 4, wherein the multilayered polycarbonate plate main body comprises a plurality of polycarbonate plates, and a plurality of spacers are connected between two polycarbonate plates face to face;
there is a spacing between an end portion of each of the plurality of spacers and the sealing portion of the at least opening end, and the spacing forms a channel connected to the plurality of spacers to divide the vacuum space into a sub space; and
the channel is located on a side where the sealing portion of the multilayered polycarbonate plate main body is located, wherein the air extraction pipeline is located at the multilayered polycarbonate plate main body.

6. The polycarbonate vacuum plate according to claim 5, wherein the vacuum space is provided with a gas absorbent and/or a vacuum degree indicator.

7. A vacuum degree indicator applicable to the polycarbonate vacuum plate according to claim 4, comprising a hollow pipe, an air bag, and a shielding portion;
wherein the air bag is hermetically sleeved at a first end of the hollow pipe, the shielding portion is connected to an end portion of the hollow pipe where the air bag is located and extends axially outwards, and a second end of the hollow pipe is sealed; and
when an external air pressure is lower than an internal air pressure of the hollow pipe, the air bag is shielded by the shielding portion; or when the external air pressure is higher than or equal to the internal air pressure of the hollow pipe, the air bag enters the hollow pipe under an action of the external air pressure and is exposed from the shielding portion.

8. The vacuum degree indicator according to claim 7, further comprising the air extraction interface with the sealing structure,
wherein a material of the hollow pipe is polycarbonate; and
the second end of the hollow pipe and the air extraction interface are of an integrally formed structure.

9. A method for preparing a polycarbonate vacuum plate, comprising the following steps:
a vacuumizing step: connecting a vacuumizing device to an air extraction interface to vacuumize a multilayered polycarbonate plate main body; and
a sealing step: heating, softening, and extruding a first portion of the air extraction interface to allow inner walls of an extruded portion of the air extraction interface continuously to fit each other to form a first section, so as to temporarily close a pipeline of the air extraction interface; hot-melting and extruding a second portion of the air extraction interface to form a sealing section, to permanently close the pipeline of the air extraction interface; and removing extrusion to the first section, wherein the inner walls of the first section are maintained to fit each other or there is a gap between the inner walls of the first section.

10. The method for preparing the polycarbonate vacuum plate according to claim 9, wherein the air extraction interface is an air extraction pipeline, and prior to the vacuumizing step, the method further comprises the following step:
a pre-treating step: hot-melting and extruding a first opening end of the multilayered polycarbonate plate main body to form a sealing portion;
milling spacers inside the multilayered polycarbonate plate main body from a second opening end of the multilayered polycarbonate plate main body, to form a first channel connected to the spacers to divide the multilayered polycarbonate plate main body into a sub space; and hot-melting and extruding the second opening end of the multilayered polycarbonate plate main body to form the air extraction pipeline with a second channel connecting the sub space to an external space of the multilayered polycarbonate plate main body;
or, the air extraction interface is an opening section of the multilayered polycarbonate plate main body.

11. The method for preparing the polycarbonate vacuum plate according to claim 10, comprising: in an extension direction of the air extraction pipeline, forming at least one first section on the first side of the sealing section, wherein the first side of the sealing section is adjacent to the second opening end of the multilayered polycarbonate plate main body; or
in the extension direction of the air extraction pipeline, forming at least one first section on the second side of the sealing section, wherein the second side of the sealing section is away from the second opening end of the multilayered polycarbonate plate main body, or skipping forming the first section, wherein
a heating temperature of the hot-melting is higher than or equal to 160° C., and a heating temperature of the softening is higher than or equal to 130° C. and lower than or equal to 140° C.; and
prior to the vacuumizing step, the method further comprises: placing a gas absorbent and/or a vacuum degree indicator inside the multilayered polycarbonate plate main body.

12. A polycarbonate vacuum plate, prepared by the method for preparing the polycarbonate vacuum plate according to claim 9.

13. A sunlight room, comprising:
splicable and detachable panels, forming a plant growth space, wherein the plant growth space is closed or semi-closed; and
an environmental conditioning system, controlling environment parameters of the plant growth space, wherein
each of the splicable and detachable panels is provided with the air extraction interface with the sealing structure according to claim 1.

14. The sunlight room according to claim 13, wherein the environmental conditioning system comprises the following apparatuses located on an airflow path of the sunlight room:
a first ventilating apparatus, configured to adjust an air power source and to provide an air pressure difference between an inside and an outside of the plant growth space by sucking or exhausting air in the plant growth space; and
a first water circulating apparatus, configured to adjust temperature and humidity in the plant growth space and to exchange air with the outside; and
the environmental conditioning system further comprises the following one or more apparatuses:
a first illumination adjusting apparatus, configured to adjust an area at which natural sunlight projected at a top of the plant growth space is shielded;
a second illumination adjusting apparatus, configured to provide a light source directly illuminated inside the plant growth space;
a second ventilating apparatus, configured to adjust a contact area where air circulates freely between the inside and the outside of the plant growth space;
a second water circulating apparatus, configured to spray clean water into the plant growth space periodically or according to temperature;
a third water circulating apparatus, configured to exchange heat between the air in the plant growth space and external underground soil;
a first irrigating apparatus, configured in a first trough shape and located on a south side and/or an east side of the plant growth space to culture plants in a water culture method or an ebb and flow irrigation method;
a second irrigating apparatus, configured in a columnar shape and located in a middle of the plant growth space, wherein a plurality of layers of petaloid grooves are stacked axially to accommodate the plants, or holes extend radially where leaves of the plants stretch, roots of the plants are left inside a column shaft, and the plants are cultured in the ebb and flow irrigation method;
a third irrigating apparatus, configured in a second trough shape and located on a north side of the plant growth space to culture the plants in a drip irrigation culture method;
a fourth irrigating apparatus, configured as a support with holes, where the plants pass through the holes, the roots are located on a backlit side of the support with holes, and the plants are cultured in an aerosol culture method;
a plurality of nutrient solution pools, mounted under a floor or on the floor of the sunlight room;
at least three fertilizing solution pools, mounted on a wall of a backlit surface of the sunlight room, wherein bottoms of the at least three fertilizing solution pools are provided with a plurality of water pipes respectively connected to the plurality of nutrient solution pools; or one fertilizing solution pool, mounted on the wall of the backlit surface of the sunlight room, wherein a bottom of the fertilizing solution pool is provided with a water pipe connected to the plurality of nutrient solution pools; and the fertilizing solution pools are located above the floor and are not shielded; and
delivery pipelines, respectively connected to the plurality of nutrient solution pools to deliver nutrient solution to the roots of the plants.

15. The sunlight room according to claim 14, further comprising a fertilizer preparing and fertilizing system, wherein the fertilizer preparing and fertilizing system comprises:
a low liquid level sensor, disposed at a first preset position within each nutrient solution pool of the plurality of nutrient solution pools;
a high liquid level sensor, disposed at a second preset position within each nutrient solution pool;
a controller, electrically connected to the low liquid level sensor and the high liquid level sensor and configured to open a tap water valve to add a preset amount of water into each nutrient solution pool when the low liquid level sensor detects that a liquid level of each nutrient solution pool is lower than the first preset position and to send a fertilization alarm signal to a mobile terminal, and to open the tap water valve to add water into each nutrient solution pool and to stir a mixture when a fertilization completion signal of the mobile terminal is received till the high liquid level sensor detects that the liquid level of each nutrient solution pool arrives at the second preset position; and
the mobile terminal, configured to prompt a user with a fertilizer required to be added and to provide an operation completion button of the fertilizer when the fertilization alarm signal is received, and to send the fertilization completion signal to the controller when the operation completion buttons of all fertilizers are triggered.

16. The air extraction interface with the sealing structure according to claim 2, wherein the sealing structure further comprises a second section located at the air extraction interface;
in the extension direction of the air extraction interface, the second section is located between the first section and the sealing section face to face, and heat resistance is formed between the first section and the sealing section in heat processing;
in the extension direction of the air extraction interface, a length of the second section is greater than or equal to 1 mm;
inner walls of pipelines of the air extraction interface where the second section is located fit each other or there is a gap or a cavity between the inner walls; and
the second section made of polycarbonate is an extruded portion allowed to be formed by heating and softening the air extraction interface.

17. The polycarbonate vacuum plate according to claim 4, wherein in the air extraction interface with the sealing structure, a material of the air extraction interface is polycarbonate;
the first section made of polycarbonate is an extruded portion allowed to be formed by heating and softening the air extraction interface;
the sealing section made of polycarbonate is a portion allowed to be formed by hot-melting the air extraction interface; and
a length of the first section in the extension direction of the air extraction interface is greater than or equal to 1 mm, and a length of the sealing section in the extension direction of the air extraction interface is greater than or equal to 1 mm.

18. The polycarbonate vacuum plate according to claim 4, wherein in the air extraction interface with the sealing structure, the sealing structure further comprises a second section located at the air extraction interface;
in the extension direction of the air extraction interface, the second section is located between the first section and the sealing section face to face, and heat resistance is formed between the first section and the sealing section in heat processing;
in the extension direction of the air extraction interface, a length of the second section is greater than or equal to 1 mm;
inner walls of pipelines of the air extraction interface where the second section is located fit each other or there is a gap or a cavity between the inner walls; and
the second section made of polycarbonate is an extruded portion allowed to be formed by heating and softening the air extraction interface.

19. The vacuum degree indicator according to claim 7, wherein in the polycarbonate vacuum plate, the multilayered polycarbonate plate main body comprises a plurality of polycarbonate plates, and a plurality of spacers are connected between two polycarbonate plates face to face;
there is a spacing between an end portion of each of the plurality of spacers and the sealing portion of the at least opening end, and the spacing forms a channel connected to the plurality of spacers to divide the vacuum space into a sub space; and
the channel is located on a side where the sealing portion of the multilayered polycarbonate plate main body is located, wherein the air extraction pipeline is located at the multilayered polycarbonate plate main body.

20. The vacuum degree indicator according to claim 19, wherein in the polycarbonate vacuum plate, the vacuum space is provided with a gas absorbent and/or a vacuum degree indicator.
